(19) United States
(12) Patent Application Publication
(10) Pub. No.: US 2020/0199349 A1
(43) Pub. Date: Jun. 25, 2020

(54) COMPOSITIONS AND METHODS OF MAKING THERMOSET FOAMS FOR SHOE SOLES

(71) Applicant: Cooper-Standard Automotive Inc., Novi, MI (US)

(72) Inventor: Krishnamachari Gopalan, Troy, MI (US)

(73) Assignee: Cooper-Standard Automotive Inc., Novi, MI (US)

(21) Appl. No.: 16/578,339

(22) Filed: Sep. 22, 2019

Related U.S. Application Data
(60) Provisional application No. 62/733,787, filed on Sep. 20, 2018.

(51) Int. Cl. C08L 51/06; C08J 9/10; C08J 9/12; C08J 9/18; A43B 13/04; A43B 13/18

(52) U.S. Cl. CPC C08L 51/06; C08L 2312/08; C08J 9/122; C08J 9/18; A43B 13/04; A43B 13/187; C08J 2203/04; C08J 2203/08; C08J 2203/22; C08J 2201/03; C08J 2351/06; C08J 2423/08; C08J 2429/14; C08J 2483/04; C08L 2203/14; C08L 2207/324; C08L 2205/03; C08J 9/103

(57) ABSTRACT

A footwear article is provided. The footwear article includes a shoe sole. The shoe sole includes a crosslinked foam polyolefin elastomer having a density less than 0.88 g/cm³, the crosslinked foam polyolefin elastomer including: a silane-grafted polyolefin elastomer, a silane-grafted olefin block copolymer, a polyolefin elastomer (POE), an olefin block copolymer (OBC), or a combination thereof; an ethylene vinyl acetate (EVA) copolymer; a crosslinker; a condensation catalyst; and a foaming agent. The shoe sole exhibits a compression set of from about 1.0% to about 50.0%, as measured according to ASTM D 395 (48 hrs @ 50° C.).

### CROSS-REFERENCE TO RELATED APPLICATION

This application claims priority from Provisional Application No. 62/733,787 filed Sep. 20, 2018, the contents of which are hereby incorporated by reference in its entirety.

### FIELD OF THE INVENTION

The present invention generally relates to polymer compositions that may be used to form shoe soles, and more particularly, to crosslinked foam polyolefin elastomers compositions used to form both midsoles and/or outsoles and dual crosslinking/self-catalyzed methods for manufacturing these shoe soles and compositions.

### BACKGROUND OF THE INVENTION

Shoe soles have been traditionally made of natural and synthetic rubbers. The use of sponge soles has been on the rise to keep pace with the increasing demand for lightweight and functional sport shoes and dress shoes alike. Many different synthetic materials used for sponge soles are known including ethylene vinyl acetate (EVA), polyurethanes (PU), and nitrile rubbers. Today, EVA sponges account for the largest market share of sponge sole materials used to form midsoles, outsoles, and aftermarket insoles using techniques that include press foaming and injection foaming processes.

For a material to find success being used in a shoe sole, the material will need to satisfy a variety of material property requirements based on its end use shoe application, such as density, rebound, grip on various types of surfaces, wear resistance, processability, and/or shock absorbance. From shoes of athletes to the elderly, the sole of the shoe must provide superior comfort, traction, and durability.

Mindful of the material property requirements for shoe soles, manufacturers have a need for the development of new polymer compositions and methods of making soles that are multifunctional, simpler to produce, lighter in weight, and have superior durability over a longer period of time.

### SUMMARY OF THE INVENTION

According to some aspects of the present disclosure, a footwear article is provided. The footwear article includes a shoe sole. The shoe sole includes a crosslinked foam polyolefin elastomer having a density less than 0.88 g/cm³. The crosslinked foam polyolefin elastomer includes: a silane-grafted polyolefin elastomer, a silane-grafted olefin block copolymer, a polyolefin elastomer (POE), an olefin block copolymer (OBC), or a combination thereof; an ethylene vinyl acetate (EVA) copolymer; a crosslinker; a condensation catalyst; and a foaming agent. The shoe sole exhibits a compression set of from about 1.0% to about 50.0%, as measured according to ASTM D 395 (48 hrs @ 50° C.).

According to other aspects of the present disclosure, a crosslinked foam polyolefin elastomer composition is provided. The composition includes a silane-grafted polyolefin having a density less than 0.86 g/cm³, a crosslinker, a condensation catalyst, and a foaming agent. The crosslinked foam polyolefin elastomer composition exhibits a compression set of from about 1.0% to about 50.0%, as measured according to ASTM D 395 (48 hrs @ 50° C.) and has a density less than 0.88 g/cm³.

According to still other aspects of the present disclosure, a method for making a shoe sole is provided. The method includes extruding a silane-grafted polyolefin, an ethylene vinyl acetate (EVA) copolymer, a crosslinker, a foaming agent, and a condensation catalyst together to form a crosslinkable polyolefin blend; injection molding the crosslinkable polyolefin blend into a shoe sole element; crosslinking the crosslinkable polyolefin blend of the shoe sole element using a dual crosslinking system to form silane graft-silane graft crosslinks and carbon-carbon crosslinks at a temperature greater than 150° C. to form a shoe sole having a density less than 0.50 g/cm³; and catalyzing the dual crosslinking system of the crosslinking step by generating acetic acid in situ from the ethylene vinyl acetate (EVA) copolymer. The shoe sole exhibits a compression set of from about 1.0% to about 50.0%, as measured according to ASTM D 395 (48 hrs @ 50° C.) and has a density less than 0.88 g/cm³.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a shoe according to some aspects of the present disclosure;

FIG. 2 is a cross-sectional perspective view of the shoe depicted in FIG. 1 according to some aspects of the present disclosure;

FIG. 3 is a flow diagram of a method for making a shoe sole according to some aspects of the present disclosure;

FIG. 4 is a schematic view of a method for making a shoe sole using a crosslinked foam polyolefin elastomer and an injection molding approach according to some aspects of the present disclosure;

FIG. 5 is a schematic cross-sectional view of a compression mold according to some aspects of the present disclosure;

FIG. 6 is a schematic cross-sectional view of an injection mold according to some aspects of the present disclosure;

FIG. 7 is a schematic cross-sectional view of an injection compression mold according to some aspects of the present disclosure;

FIG. 8 is a schematic cross-sectional view of an extruder equipped with a supercritical fluid injector according to some aspects of the present disclosure;

FIG. 9 is a resilience versus specific gravity plot for a variety of crosslinked materials according to some aspects of the present disclosure;

FIG. 10 is a hardness versus specific gravity plot for a variety of crosslinked materials according to some aspects of the present disclosure;

FIG. 11 is a micrograph of a cross-sectioned midsole formed using a supercritical fluid foaming process according to some aspects of the present disclosure;

FIG. 12 is a series of micrographs taken from a cross-sectioned midsole formed using a chemical foaming agent according to some aspects of the present disclosure;

FIG. 13 is a micrograph of a cross-sectioned midsole formed using a high density silane-graft polyolefin and a chemical blowing agent according to some aspects of the present disclosure;

FIG. 14 is a micrograph of a cross-sectioned midsole formed using a low density silane-graft polyolefin and a chemical blowing agent according to some aspects of the present disclosure; and

FIG. 15 is a static compression plot providing compressive strength versus compressive strain for a variety of commercially available shoe soles according to some aspects of the present disclosure;

FIG. 16 is a static compression plot providing compressive strength versus compressive strain for a variety of crosslinked foamed polyolefin elastomers according to some aspects of the present disclosure;

FIG. 17 is a static compression plot providing compressive strength versus compressive strain for a variety of crosslinked foamed polyolefin elastomers according to some aspects of the present disclosure;

FIG. 18 is a load versus position plot of an inventive crosslinked foamed polyolefin elastomers according to some aspects of the present disclosure;

FIG. 19 is a graph depicting volume loss over 1000 cycles for a variety of crosslinked foamed polyolefin elastomers according to some aspects of the present disclosure; and

FIG. 20 is a graph illustrating the compression set of an inventive crosslinked foamed polyolefin elastomer as plotted with respect to temperatures ranging from 100° C. to 150° C.

### DETAILED DESCRIPTION

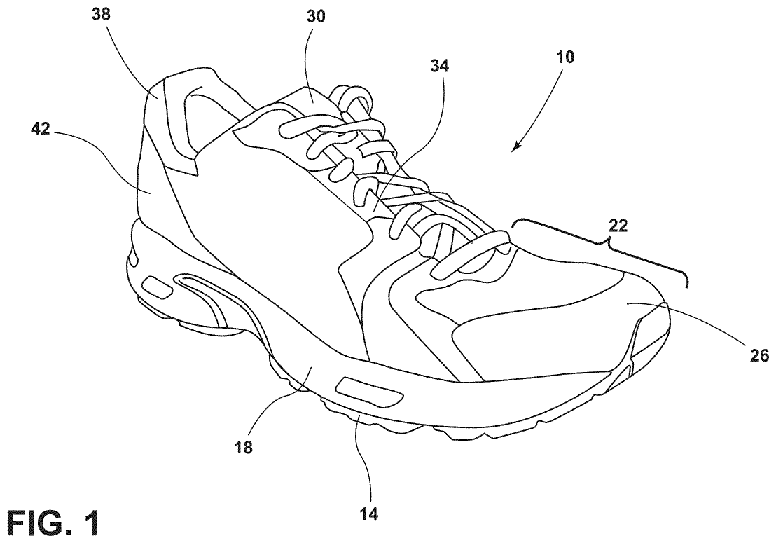

For purposes of description herein the terms “upper,” “lower,” “right,” “left,” “rear,” “front,” “vertical,” “horizontal,” and derivatives thereof shall relate to the shoe soles of the disclosure as oriented in the shoe shown in FIG. 1. However, it is to be understood that the shoe soles, compositions and methods may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.”

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

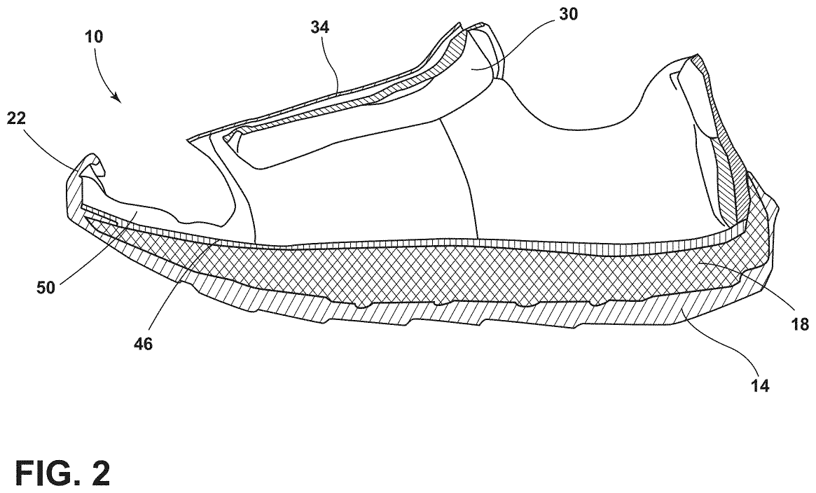

Referring to FIGS. 1-2, a footwear article is disclosed. The footwear article may include a shoe sole including, for example, a show outsole and/or a shoe midsole. In the embodiments provided, the shoe sole, shoe outsole, and/or shoe midsole includes a crosslinked foam polyolefin elastomer having a density less than 0.88 g/cm³. The crosslinked foam polyolefin elastomer includes a silane-grafted polyolefin elastomer, a silane-grafted olefin block copolymer, a polyolefin elastomer (POE), an olefin block copolymer (OBC), or a combination thereof. The crosslinked foam polyolefin elastomer additionally includes an ethylene vinyl acetate (EVA) copolymer, a crosslinker, a condensation catalyst, and a foaming agent. Each of the shoe sole and shoe midsole exhibits a compression set of from about 1.0% to about 50.0%, as measured according to ASTM D 395 (48 hrs @ 50° C.).

Referring now to FIG. 1, a perspective view of a shoe 10 is provided. The shoe 10 includes an outsole 14 coupled to a midsole 18 where the midsole 18 is positioned directly above the outsole 14. A toe box 22 makes up a front portion of the shoe 10 in combination with a toe cap 26. The toe box 22 and toe cap 26 are positioned to support and enclose toes of a foot. A tongue 30 works in combination with uppers 34 to support the top of the foot. A collar 38 and a heal counter 42 are positioned at a rear of the shoe 10 and work together to comfortably position and retain a heel in the shoe 10. Although the footwear depicted in FIG. 1 is a running shoe, the shoe 10 is not meant to be limiting and the shoe 10 could additionally include, for example, other athletic shoes, sandals, hiking boots, winter boots, dress shoes, and medical orthotic shoes.

Referring now to FIG. 2, a cross-sectional view of the shoe 10 depicted in FIG. 1 is provided. This cross-sectional view provides the respective thickness of the outsole 14 compared to the midsole 18. The midsole 18 is the part of the shoe 10 that is sandwiched between the outsole 14 and an instep liner 46 that provides cushioning and rebound, while helping protect the foot from feeling hard or sharp objects. The foot is in contact with a sock liner 50 that is positioned as a top layer on the instep liner 46 while the foot's positioning in the interior of the shoe 10 is maintained with the toe box 22, tongue 30, and uppers 34.

Midsoles 18 provide stability for the foot, necessitating that the material used to fabricate the midsole 18 be designed to endure all types of challenges typical of foot wear—i.e., terrain, the user's weight, and pressure sources incurred during walking or running, etc. The most common materials used in the manufacture of midsoles are the expanded foam rubber version forms of ethylene vinyl acetate (EVA). Like most rubbers, EVA is soft and flexible, but it is also easy to process and manipulate in the manufacturing of versatile articles (midsoles included) due to its thermoplastic properties. While EVA is typically selected as the desired material to produce midsoles because of its “low-temperature” toughness, stress-crack resistance, waterproof properties, and resistance to UV-radiation, the biggest critique against EVA is its short life. Over time, EVA tends to compress and users (runners especially) say that they feel their shoes go flat after a period of time. Currently, the only way to avoid this flattening of the EVA midsole is to replace one's shoes every 3 to 6 months.

As an alternative to EVA, disclosed herein is a family of crosslinked foam polyolefin elastomers. The elastomers of the disclosure provide many of the same advantages as EVA, but they also offer many improved material properties including, for example, density, rebound, compression set, and durability. The crosslinked foam polyolefin elastomers, and the variety of techniques used to mold shoe soles disclosed herein, produce lightweight materials containing thousands of tiny bubbles that provide cushioning and shock absorption to users. One of the properties that makes the disclosed crosslinked foam polyolefin elastomers better than EVA and other conventional shoe sole materials is the relative lightness of these elastomers. The crosslinked foam polyolefin elastomers have a low density, making them ideal materials used in footwear where weight is an issue.

The disclosure herein focuses on the composition, method of making the composition, and the corresponding material properties for the crosslinked foam polyolefin elastomers used to make shoe soles, for example, outsoles 14 and midsoles 18. The shoe sole can be formed from a silane-grafted polyolefin where the silane-grafted polyolefin may have a catalyst added to form a silane-crosslinkable polyolefin elastomer. This silane-crosslinkable polyolefin may then be crosslinked upon exposure to moisture and/or heat to form the final crosslinked foam polyolefin elastomers or blend. In aspects, the crosslinked foam polyolefin elastomers or blend includes the silane-grafted polyolefin having a density less than 0.86 g/cm³, an ethylene vinyl acetate (EVA) copolymer, a crosslinker, a condensation catalyst, and a foaming agent.

The disclosure herein additionally focuses on silane-grafted polyolefin elastomers, silane-grafted olefin block copolymers, or silane grafted blends of polyolefin elastomers (POEs) and olefin block copolymers (OBCs) dry mixed with an ethylene vinyl acetate (EVA) copolymer material including at least one peroxide, at least one blowing agent, and/or at least one tin or acid based condensation catalyst. An injection molding system can then melt and activate this corresponding dry mix to form a dual crosslinking system. This dual crosslinking system can provide both silane graft-silane graft crosslinks and carbon-carbon crosslinks along the hydrocarbon backbone. The incorporation of both silane graft-silane graft and carbon-carbon backbone crosslinks can afford foamed articles that provide exceptional material properties including compression set, rebound resilience, and hardness levels that are ideal for footwear applications.

### Silane-Grafted Polyolefin

The silane-grafted polyolefin may include a silane-grafted polyolefin elastomer, a silane-grafted olefin block copolymer, a polyolefin elastomer (POE), an olefin block copolymer (OBC), or a combination thereof. Each of these silane-grafted polyolefin elastomer, silane-grafted olefin block copolymer, polyolefin elastomer (POE), and olefin block copolymer (OBC) materials may be formed using at least one polyolefin. The following disclosure outlines the types of monomers and resultant polymers systems that can be used to synthesize the crosslinked foam polyolefin elastomers disclosed herein.

The at least one polyolefin can be a polyolefin elastomer including an olefin block copolymer, an ethylene/α-olefin copolymer, a propylene/α-olefin copolymer, EPDM, EPM, or a mixture of two or more of any of these materials. Exemplary block copolymers include those sold under the trade names INFUSE™, an olefin block co-polymer (the Dow Chemical Company) and SEPTON™ V-SERIES, a styrene-ethylene-butylene-styrene block copolymer (Kuraray Co., LTD.). Exemplary ethylene/α-olefin copolymers include those sold under the trade names TAFMER™ (e.g., TAFMER DF710) (Mitsui Chemicals, Inc.), and ENGAGE™ (e.g., ENGAGE 8150) (the Dow Chemical Company). Exemplary propylene/α-olefin copolymers include those sold under the trade name VISTAMAXX™ 6102 grades (Exxon Mobil Chemical Company), TAFMER™ XM (Mitsui Chemical Company), and VERSIFY™ (Dow Chemical Company). The EPDM may have a diene content of from about 0.5 to about 10 wt %. The EPM may have an ethylene content of 45 wt % to 75 wt %.

The term “comonomer” refers to olefin comonomers which are suitable for being polymerized with olefin monomers, such as ethylene or propylene monomers. Comonomers may comprise but are not limited to aliphatic C₂-C₂₀ α-olefins. Examples of suitable aliphatic C₂-C₂₀ α-olefins include ethylene, propylene, 1-butene, 4-methyl-1-pentene, 1-hexene, 1-octene, 1-decene, 1-dodecene, 1-tetradecene, 1-hexadecene, 1- octadecene and 1-eicosene. In an embodiment, the comonomer is vinyl acetate. The term “copolymer” refers to a polymer, which is made by linking more than one type of monomer in the same polymer chain. The term “homopolymer” refers to a polymer which is made by linking olefin monomers, in the absence of comonomers. The amount of comonomer can, in some embodiments, be from greater than 0 wt % to about 12 wt % based on the weight of the polyolefin, including from greater than 0 wt % to about 9 wt %, and from greater than 0 wt % to about 7 wt %. In some embodiments, the comonomer content is greater than about 2 mol % of the final polymer, including greater than about 3 mol % and greater than about 6 mol %. The comonomer content may be less than or equal to about 30 mol %. A copolymer can be a random or block (heterophasic) copolymer. In some embodiments, the polyolefin is a random copolymer of propylene and ethylene.

In some aspects, the at least one polyolefin is selected from the group consisting of: an olefin homopolymer, a blend of homopolymers, a copolymer made using two or more olefins, a blend of copolymers each made using two or more olefins, and a combination of olefin homopolymers blended with copolymers made using two or more olefins. The olefin may be selected from ethylene, propylene, 1-butene, 1-propene, 1-hexene, 1-octene, and other higher 1-olefin. The at least one polyolefin may be synthesized using many different processes (e.g., using gas phase and solution based metallocene catalysis and Ziegler-Natta catalysis) and optionally using a catalyst suitable for polymerizing ethylene and/or α-olefins. In some aspects, a metallocene catalyst may be used to produce low density ethylene/α-olefin polymers.

In some aspects, the polyethylene used for the at least one polyolefin can be classified into several types including, but not limited to, LDPE (Low Density Polyethylene), LLDPE (Linear Low Density Polyethylene), and HDPE (High Density Polyethylene). In other aspects, the polyethylene can be classified as Ultra High Molecular Weight (UHMW), High Molecular Weight (HMW), Medium Molecular Weight (MMW) and Low Molecular Weight (LMW). In still other aspects, the polyethylene may be an ultra-low density ethylene elastomer.

In some aspects, the at least one polyolefin may include a LDPE/silane copolymer or blend. In other aspects, the at least one polyolefin may be polyethylene that can be produced using any catalyst known in the art including, but not limited to, chromium catalysts, Ziegler-Natta catalysts, metallocene catalysts or post-metallocene catalysts.

In some aspects, the at least one polyolefin may have a molecular weight distribution M_{w}/Mₙ of less than or equal to about 5, less than or equal to about 4, from about 1 to about 3.5, or from about 1 to about 3.

The at least one polyolefin may be present in an amount of from greater than 0 wt % to about 100 wt % of the composition. In some embodiments, the amount of polyolefin elastomer is from about 30 wt % to about 70 wt %. In some aspects, the at least one polyolefin fed to an extruder can include from about 50 wt % to about 80 wt % of an ethylene/α-olefin copolymer, including from about 60 wt % to about 75 wt % and from about 62 wt % to about 72 wt %.

The at least one polyolefin may have a melt viscosity in the range of from about 2,000 cP to about 50,000 cP as measured using a Brookfield viscometer at a temperature of about 177° C. In some embodiments, the melt viscosity is from about 4,000 cP to about 40,000 cP, including from about 5,000 cP to about 30,000 cP and from about 6,000 cP to about 18,000 cP.

The at least one polyolefin may have a melt index (T2), measured at 190° C. under a 2.16 kg load, of from about 20.0 g/10 min to about 3,500 g/10 min, including from about 250 g/10 min to about 1,900 g/10 min and from about 300 g/10 min to about 1,500 g/10 min. In some aspects, the at least one polyolefin has a fractional melt index of from 0.5 g/10 min to about 3,500 g/10 min.

In some aspects, the density of the at least one polyolefin is less than about 0.90 g/cm³, less than about 0.89 g/cm³, less than about 0.88 g/cm³, less than about 0.87 g/cm³, less than about 0.86 g/cm³, less than about 0.85 g/cm³, less than about 0.84 g/cm³, less than about 0.83 g/cm³, less than about 0.82 g/cm³, less than about 0.81 g/cm³, or less than about 0.80 g/cm³. In other aspects, the density of the at least one polyolefin may be from about 0.85 g/cm³ to about 0.89 g/cm³, from about 0.85 g/cm³ to about 0.88 g/cm³, from about 0.84 g/cm³ to about 0.88 g/cm³, or from about 0.83 g/cm³ to about 0.87 g/cm³. In still other aspects, the density is at about 0.84 g/cm³, about 0.85 g/cm³, about 0.86 g/cm³, about 0.87 g/cm³, about 0.88 g/cm³, or about 0.89 g/cm³.

The percent crystallinity of the at least one polyolefin may be less than about 60%, less than about 50%, less than about 40%, less than about 35%, less than about 30%, less than about 25%, or less than about 20%. The percent crystallinity may be at least about 10%. In some aspects, the crystallinity is in the range of from about 2% to about 60%.

As noted, in some aspects, the crosslinked foam polyolefin elastomers or blend, e.g., as employed in the shoe soles (see FIGS. 1-2), may include two or more polyolefins. In some aspects, more than one polyolefin is generally used to modify the hardness and/or processability of the first polyolefin, which has a density less than 0.90 g/cm³. In some aspects, more than just the first and second polyolefins may be used to form the crosslinked foam polyolefin elastomers or blend. For example, in some aspects, one, two, three, four, or more different polyolefins having a density less than 0.90 g/cm³, less than 0.89 g/cm³, less than 0.88 g/cm³, less than 0.87 g/cm³, less than 0.86 g/cm³, or less than 0.85 g/cm³ may be substituted and/or used for the first polyolefin. In some aspects, one, two, three, four, or more different polyolefins, polyethylene-co-propylene copolymers may be substituted and/or used for the second polyolefin.

In some aspects, the first and second polyolefins may further include one or more TPVs and/or EPDM with or without silane graft moieties where the TPV and/or EPDM polymers are present in an amount of up to 20 wt % of the silane-crosslinked polyolefin elastomer/blend.

The grafting initiator (also referred to as “a radical initiator” in the disclosure) can be utilized in the grafting process of at least one polyolefin by reacting with the respective polyolefin to form a reactive species that can react and/or couple with the silane crosslinker molecule. The grafting initiator can include halogen molecules, azo compounds (e.g., azobisisobutyl), carboxylic peroxyacids, peroxyesters, peroxyketals, and peroxides (e.g., alkyl hydroperoxides, dialkyl peroxides, and diacyl peroxides). In some embodiments, the grafting initiator is an organic peroxide selected from di-t-butyl peroxide, t-butyl cumyl peroxide, dicumyl peroxide, 2,5-dimethyl-2,5-di(t-butyl- peroxy)hexyne-3, 1,3-bis(t-butyl-peroxy-isopropyl)benzene, n-butyl-4,4-bis(t-butyl- peroxy)valerate, benzoyl peroxide, t-butylperoxybenzoate, t-butylperoxy isopropyl carbonate, and t-butylperbenzoate, as well as bis(2-methylbenzoyl)peroxide, bis(4- methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylperoxy)-1,4-diisopropylbenzene, 2,5-bis(t-butylperoxy)-2,5-dimethylhexane, and 2,5-bis(t-butylperoxy)-2,5-dimethyl-3- hexyne and 2,4-dichlorobenzoyl peroxide. Exemplary peroxides include those sold under the tradename LUPEROX™ (available from Arkema, Inc.).

In some aspects, the grafting initiator is present in an amount of from greater than 0 wt % to about 2 wt % of the composition, including from about 0.15 wt % to about 1.2 wt % of the composition. The amount of initiator and silane employed may affect the final structure of the silane grafted polymer (e.g., the degree of grafting in the grafted polymer and the degree of crosslinking in the cured polymer). In some aspects, the reactive composition contains at least 100 ppm of initiator, or at least 300 ppm of initiator. The initiator may be present in an amount from 300 ppm to 1500 ppm or from 300 ppm to 2000 ppm. The silane:initiator weight ratio may be from about 20:1 to about 400:1, including from about 30:1 to about 400:1, from about 48:1 to about 350:1, and from about 55:1 to about 333:1.

The grafting reaction can be performed under conditions that optimize grafts onto the interpolymer backbone while minimizing side reactions (e.g., the homopolymerization of the grafting agent). The grafting reaction may be performed in a melt, in solution, in a solid-state, and/or in a swollen-state. The silanation may be performed in a wide-variety of equipment (e.g., twin screw extruders, single screw extruders, Brabenders, internal mixers such as Banbury mixers, and batch reactors). In some embodiments, the polyolefin, silane, and initiator are mixed in the first stage of an extruder. The melt temperature (i.e., the temperature at which the polymer starts melting and begins to flow) may be from about 120° C. to about 260° C., including from about 130° C. to about 250° C.

A silane crosslinker can be used to covalently graft silane moieties onto the at least one polyolefin and the silane crosslinker may include alkoxysilanes, silazanes, siloxanes, or a combination thereof. The grafting and/or coupling of the various potential silane crosslinkers or silane crosslinker molecules is facilitated by the reactive species formed by the grafting initiator reacting with the respective silane crosslinker.

In some aspects, the silane crosslinker is a silazane where the silazane may include, for example, hexamethyldisilazane (HMDS) or bis(trimethylsilyl)amine. In some aspects, the silane crosslinker is a siloxane where the siloxane may include, for example, polydimethylsiloxane (PDMS) and octamethylcyclotetrasiloxane.

In some aspects, the silane crosslinker is an alkoxysilane. As used herein, the term “alkoxysilane” refers to a compound that comprises a silicon atom, at least one alkoxy group and at least one other organic group, wherein the silicon atom is bonded with the organic group by a covalent bond. In some aspects, the alkoxysilane is selected from alkylsilanes; acryl-based silanes; vinyl-based silanes; aromatic silanes; epoxy-based silanes; amino-based silanes and amines that possess —NH₂, —NHCH₃ or —N(CH₃)₂; ureide-based silanes; mercapto-based silanes; and alkoxysilanes which have a hydroxyl group (i.e., —OH). An acryl-based silane may be selected from the group comprising beta-acryloxyethyl trimethoxysilane; beta-acryloxy propyl trimethoxysilane; gamma-acryloxyethyl trimethoxysilane; gamma-acryloxypropyl trimethoxysilane; beta-acryloxyethyl triethoxysilane; beta-acryloxypropyl triethoxysilane; gamma-acryloxyethyl triethoxysilane; gamma-acryloxypropyl triethoxysilane; beta-methacryloxyethyl trimethoxysilane; beta-methacryloxypropyl trimethoxysilane; gamma-methacryloxyethyl trimethoxysilane; gamma-methacryloxypropyl trimethoxysilane; beta-methacryloxyethyl triethoxysilane; beta-methacryloxypropyl triethoxysilane; gamma-methacryloxyethyl triethoxysilane; gamma-methacryloxypropyl triethoxysilane; 3-methacryloxypropylmethyl diethoxysilane. A vinyl-based silane may be selected from the group comprising vinyl trimethoxysilane; vinyl triethoxysilane; p-styryl trimethoxysilane, methylvinyldimethoxysilane, vinyldimethylmethoxysilane, divinyldimethoxysilane, vinyltris(2-methoxyethoxy)silane, and vinylbenzylethylenediaminopropyltrimethoxysilane. An aromatic silane may be selected from phenyltrimethoxysilane and phenyltriethoxysilane. An epoxy-based silane may be selected from the group comprising 3-glycydoxypropyl trimethoxysilane; 3-glycydoxypropylmethyl diethoxysilane; 3-glycydoxypropyl triethoxysilane; 2-(3,4-epoxycyclohexyl)ethyl trimethoxysilane, and glycidyloxypropylmethyldimethoxysilane. An amino-based silane may be selected from the group comprising 3-aminopropyl triethoxysilane; 3-aminopropyl trimethoxysilane; 3-aminopropyldimethyl ethoxysilane; 3-aminopropylmethyldiethoxysilane; 4-aminobutyltriethoxysilane; 3- aminopropyldiisopropyl ethoxysilane; 1-amino-2-(dimethylethoxysilyl)propane; (aminoethylamino)-3-isobutyldimethyl methoxysilane; N-(2-aminoethyl)-3-aminoisobutylmethyl dimethoxysilane; (aminoethylaminomethyl)phenetyl trimethoxysilane; N-(2-aminoethyl)-3-aminopropylmethyl dimethoxysilane; N-(2-aminoethyl)-3-aminopropyl trimethoxysilane; N-(2-aminoethyl)-3-aminopropyl triethoxysilane; N-(6-aminohexyl)aminomethyl trimethoxysilane; N-(6-aminohexyl)aminomethyl trimethoxysilane; N-(6-aminohexyl)aminopropyl trimethoxysilane; N-(2-aminoethyl)-1,1-aminoundecyltrimethoxysilane; 1,1-aminoundecyl triethoxysilane; 3-(m-aminophenoxy)propyl trimethoxysilane; m-aminophenyl trimethoxysilane; p-aminophenyl trimethoxysilane; (3-trimethoxysilylpropyl)diethylenetriamine; N-methylaminopropylmethyl dimethoxysilane; N- methylaminopropyl trimethoxysilane; dimethylaminomethyl ethoxysilane; (N,N-dimethylaminopropyl)trimethoxysilane; (N-acetylglycysil)-3-aminopropyl trimethoxysilane, N-phenyl-3-aminopropyltrimethoxysilane, N-phenyl-3-aminopropyltriethoxysilane, phenylaminopropyltrimethoxysilane, aminoethylaminopropyltrimethoxysilane, and aminoethylaminopropylmethyldimethoxysilane. An ureide-based silane may be 3-ureidepropyl triethoxysilane. A mercapto-based silane may be selected from the group comprising 3-mercaptopropylmethyl dimethoxysilane, 3-mercaptopropyl trimethoxysilane, and 3-mercaptopropyl triethoxysilane. An alkoxysilane having a hydroxyl group may be selected from the group comprising hydroxymethyl triethoxysilane; N-(hydroxyethyl)-N-methylaminopropyl trimethoxysilane; bis(2-hydroxyethyl)-3-aminopropyl triethoxysilane; N-(3-triethoxysilylpropyl)-4-hydroxy butylamide; 1,1-(triethoxysilyl)undecanol; triethoxysilyl undecanol; ethylene glycol acetal; and N-(3-ethoxysilylpropyl)gluconamide.

In some aspects, the alkylsilane may be expressed with a general formula: RₙSi(OR′)₄₋ₙ wherein: n is 1, 2 or 3; R is a C₁₋₂₀ alkyl or a C₂₋₂₀ alkenyl; and R′ is an C₁₋₂₀ alkyl. The term “alkyl” by itself or as part of another substituent, refers to a straight, branched or cyclic saturated hydrocarbon group joined by single carbon-carbon bonds having 1 to 20 carbon atoms, for example 1 to 10 carbon atoms, for example 1 to 8 carbon atoms, preferably 1 to 6 carbon atoms. When a subscript is used herein following a carbon atom, the subscript refers to the number of carbon atoms that the named group may contain. Thus, for example, C₁₋₆ alkyl means an alkyl of one to six carbon atoms. Examples of alkyl groups are methyl, ethyl, propyl, isopropyl, butyl, isobutyl, sec-butyl, f-butyl, 2-methylbutyl, pentyl, iso-amyl and its isomers, hexyl and its isomers, heptyl and its isomers, octyl and its isomer, decyl and its isomer, dodecyl and its isomers. The term “C₂₋₂₀alkenyl” by itself or as part of another substituent, refers to an unsaturated hydrocarbyl group, which may be linear, or branched, comprising one or more carbon-carbon double bonds having 2 to 20 carbon atoms. Examples of C₂₋₆ alkenyl groups are ethenyl, 2-propenyl, 2-butenyl, 3-butenyl, 2-pentenyl and its isomers, 2-hexenyl and its isomers, 2,4-pentadienyl and the like.

In some aspects, the alkylsilane may be selected from the group comprising methyltrimethoxysilane; methyltriethoxysilane; ethyltrimethoxysilane; ethyltriethoxysilane; propyltrimethoxysilane; propyltriethoxysilane; hexyltrimethoxysilane; hexyltriethoxysilane; octyltrimethoxysilane; octyltriethoxysilane; decyltrimethoxysilane; decyltriethoxysilane; dodecyltrimethoxysilane: dodecyltriethoxysilane; tridecyltrimethoxysilane; dodecyltriethoxysilane; hexadecyltrimethoxysilane; hexadecyltriethoxysilane; octadecyltrimethoxysilane; octadecyltriethoxysilane, trimethylmethoxysilane, methylhydrodimethoxysilane, dimethyldimethoxysilane, diisopropyldimethoxysilane, diisobutyldimethoxysilane, isobutyltrimethoxysilane, n-butyltrimethoxysilane, n-butylmethyldimethoxysilane, phenyltrimethoxysilane, phenyltrimethoxysilane, phenylmethyldimethoxysilane, triphenylsilanol, n-hexyltrimethoxysilane, n-octyltrimethoxysilane, isooctyltrimethoxysilane, decyltrimethoxysilane, hexadecyltrimethoxysilane, cyclohexylmethyldimethoxysilane, cyclohexylethyldimethoxysilane, dicyclopentyldimethoxysilane, tert-butylethyldimethoxysilane, tert-butylpropyldimethoxysilane, dicyclohexyldimethoxysilane, and a combination thereof.

In some aspects, the alkylsilane compound may be selected from triethoxyoctylsilane, trimethoxyoctylsilane, and a combination thereof.

Additional examples of silanes that can be used as silane crosslinkers include, but are not limited to, those of the general formula CH₂═CR—(COO)ₓ(CₙFH₂ₙ)_{y}SiR′₃, wherein R is a hydrogen atom or methyl group; x is 0 or 1; y is 0 or 1; n is an integer from 1 to 12; each R′ can be an organic group and may be independently selected from an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms. x and y may both equal 1. In some aspects, no more than one of the three R′ groups is an alkyl. In other aspects, not more than two of the three R′ groups is an alkyl.

Any silane or mixture of silanes known in the art that can effectively graft to and crosslink an olefin polymer can be used in the practice of the present disclosure. In some aspects, the silane crosslinker can include, but is not limited to, unsaturated silanes which include an ethylenically unsaturated hydrocarbyl group (e.g., a vinyl, allyl, isopropenyl, butenyl, cyclohexenyl or a gamma-(meth)acryloxy allyl group) and a hydrolyzable group (e.g., a hydrocarbyloxy, hydrocarbonyloxy, or hydrocarbylamino group). Non-limiting examples of hydrolyzable groups include, but are not limited to, methoxy, ethoxy, formyloxy, acetoxy, proprionyloxy, and alkyl, or arylamino groups. In other aspects, the silane crosslinkers are unsaturated alkoxy silanes which can be grafted onto the polymer. In still other aspects, additional exemplary silane crosslinkers include vinyltrimethoxysilane, vinyltriethoxysilane, 3-(trimethoxysilyl)propyl methacrylate gamma-(meth)acryloxypropyl trimethoxysilane), and mixtures thereof.

The silane crosslinker may be present in the silane-grafted polyolefin elastomer in an amount of from greater than 0 wt % to about 10 wt %, including from about 0.5 wt % to about 5 wt %. The amount of silane crosslinker may be varied based on the nature of the olefin polymer, the silane itself, the processing conditions, the grafting efficiency, the application, and other factors. The amount of silane crosslinker may be at least 2 wt %, including at least 4 wt % or at least 5 wt %, based on the weight of the reactive composition. In other aspects, the amount of silane crosslinker may be at least 10 wt %, based on the weight of the reactive composition. In still other aspects, the silane crosslinker content is at least 1% based on the weight of the reactive composition. In some embodiments, the silane crosslinker fed to the extruder may include from about 0.5 wt % to about 10 wt % of silane monomer, from about 1 wt % to about 5 wt % silane monomer, or from about 2 wt % to about 4 wt % silane monomer.

### Ethylene Vinyl Acetate (EVA) Copolymer

The ethylene vinyl acetate (EVA) copolymer may include a variety of different structures and monomer content to provide the desired catalyst activity and/or final material properties for the crosslinked foam polyolefin elastomer. For example, in some aspects, the EVA copolymer may be an alternating copolymer, a block copolymer, a random copolymer, an AB block copolymer, an ABA block copolymer, or an ABABA copolymer. In some aspects, vinyl acetate may be polymerized using any catalyst or polymerization system known in the art to form a block or random copolymer with ethylene, propylene, 1-butene, 1-propene, 1-hexene, 1-octene, and higher and lower α-olefins.

The amount of vinyl acetate present in the EVA or other vinyl acetate-co-α-olefin copolymer may be from greater than 0 wt % to about 75 wt %, from greater than 0 wt % to about 50 wt %, from greater than 0 wt % to about 25 wt %, from about 5 wt % to about 25 wt %, from about 10 wt % to about 25 wt %, from about 10 wt % to about 66 wt %, from about 25 wt % to about 50 wt %, from about 15 wt % to about 35 wt %, and from about 25 wt % to about 75 wt %. In some embodiments, the vinyl acetate monomer content is greater than about 2 mol % of the final polymer, greater than about 3 mol %, greater than about 6 mol %, greater than about 10 mol % of the final polymer, greater than about 15 mol %, greater than about 20 mol %, greater than about 25 mol %, greater than about 35 mol %, less than about 2 mol % of the final polymer, less than about 3 mol %, less than about 6 mol %, less than about 10 mol % of the final polymer, less than about 15 mol %, less than about 20 mol %, less than about 25 mol %, or less than about 35 mol % of the final EVA polymer or other vinyl acetate-co-α-olefin copolymer. In some aspects, the comonomer content may be less than or equal to about 30 mol %.

The EVA copolymer and/or alternative vinyl acetate-co-α-olefin copolymer provide a catalytic effect to the crosslinking reaction of silane grafts to silane grafts, silane grafts to the carbon backbone, and carbon to carbon along the polymer backbones. The acetate functionality positioned along the respective polymer backbone is in equilibrium between the associated acetate group bound to the polymer and the acetic acid molecule. Not to be bound by theory, acetic acid is believed to facilitate radical formation and stability permitting more efficient crosslinking reactions.

In some aspects, the crosslinking foam polyolefin elastomer may alternatively and/or additionally tuned for desired material properties by applying acetic acid, a protic acid, and/or a Lewis acid based catalyst. In some aspects, the acid catalyst may be a Bronsted type acid with a pKa less than 20, less than 15, less than 10, less than 5, less than 4, less than 3, less than 2, less than 1, or even less than zero.

### Crosslinker

The crosslinker can be utilized to initiate the crosslinking process of the polyolefin elastomer and/or the ethylene vinyl acetate (EVA) copolymer by reacting with the respective polyolefins to form a reactive species that can react and/or couple with the respective polyolefin elastomer and/or the ethylene vinyl acetate (EVA) copolymer chains. The crosslinker can include halogen molecules, azo compounds (e.g., azobisisobutyl), carboxylic peroxyacids, peroxyesters, peroxyketals, and peroxides (e.g., alkyl hydroperoxides, dialkyl peroxides, and diacyl peroxides). In some embodiments, the crosslinker is an organic peroxide selected from di-t-butyl peroxide, t-butyl cumyl peroxide, dicumyl peroxide, 2,5-dimethyl-2,5-di(t-butyl-peroxy)hexyne-3,1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, and t-butylperbenzoate, as well as bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t- butylperoxy)-1,3-diisopropylbenzene, α,α′-bis(t-butylpexoxy)-1,4-diisopropylbenzene, 2,5-bis(t-butylperoxy)-2,5-dimethylhexane, and 2,5-bis(t-butylperoxy)-2,5-dimethyl-3-hexyne and 2,4-dichlorobenzoyl peroxide. Exemplary peroxides include those sold under the tradename LUPEROX™ (available from Arkema, Inc.). In some aspects, the crosslinker can include a peroxide.

In some aspects, the grafting initiator is present in an amount of from greater than 0 wt % to about 2 wt % of the composition, including from about 0.15 wt % to about 1.2 wt % of the composition. The amount of initiator and silane employed may affect the final structure of the silane grafted polymer (e.g., the degree of grafting in the grafted polymer and the degree of crosslinking in the cured polymer). In some aspects, the reactive composition contains at least 100 ppm of initiator, or at least 300 ppm of initiator. The initiator may be present in an amount from 300 ppm to 1500 ppm or from 300 ppm to 2000 ppm. The silane:initiator weight ratio may be from about 20:1 to about 400:1, including from about 30:1 to about 400:1, from about 48:1 to about 350:1, and from about 55:1 to about 333:1.

As previously disclosed, the crosslinker present in the dry mix (crosslinker, silane-grafted polyolefin, EVA, condensation catalyst, and/or foaming agent) can form a dual crosslinking system. This dual crosslinking system can provide both silane graft-silane graft crosslinks and carbon-carbon crosslinks along the hydrocarbon backbone. The incorporation of both silane graft-silane graft and carbon-carbon backbone crosslinks can afford foamed articles that provide exceptional material properties including compression set, rebound resilience, and hardness levels that are ideal for footwear applications.

### Condensation Catalyst

The condensation catalyst can facilitate both the hydrolysis and subsequent condensation of the silane grafts on the silane-grafted polyolefin elastomer to form crosslinks. In some aspects, the crosslinking can be aided by the use of an electron beam radiation. In some aspects, the condensation catalyst can include, for example, organic bases, carboxylic acids, and organometallic compounds (e.g., organic titanates and complexes or carboxylates of lead, cobalt, iron, nickel, zinc, and tin). In other aspects, the condensation catalyst can include fatty acids and metal complex compounds such as metal carboxylates; aluminum triacetyl acetonate, iron triacetyl acetonate, manganese tetraacetyl acetonate, nickel tetraacetyl acetonate, chromium hexaacetyl acetonate, titanium tetraacetyl acetonate and cobalt tetraacetyl acetonate; metal alkoxides such as aluminum ethoxide, aluminum propoxide, aluminum butoxide, titanium ethoxide, titanium propoxide and titanium butoxide; metal salt compounds such as sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate and dibutyltin di(2-ethylhexanoate); acidic compounds such as formic acid, acetic acid, propionic acid, p-toluenesulfonic acid, trichloroacetic acid, phosphoric acid, monoalkylphosphoric acid, dialkylphosphoric acid, phosphate ester of p-hydroxyethyl (meth)acrylate, monoalkylphosphorous acid and dialkylphosphorous acid; acids such as p-toluenesulfonic acid, phthalic anhydride, benzoic acid, benzenesulfonic acid, dodecylbenzenesulfonic acid, formic acid, acetic acid, itaconic acid, oxalic acid and maleic acid, ammonium salts, lower amine salts or polyvalent metal salts of these acids, sodium hydroxide, lithium chloride; organometal compounds such as diethyl zinc and tetra(n-butoxy)titanium; and amines such as dicyclohexylamine, triethylamine, N,N-dimethylbenzylamine, N,N,NT,NT-tetramethyl-1,3-butanediamine, diethanolamine, triethanolamine and cyclohexylethylamine. In still other aspects, the condensation catalyst can include ibutyltindilaurate, dioctyltinmaleate, dibutyltindiacetate, dibutyltindioctoate, stannous acetate, stannous octoate, lead naphthenate, zinc caprylate, and cobalt naphthenate. Depending on the desired final material properties of the crosslinked foam polyolefin elastomers or blend, a single condensation catalyst or a mixture of condensation catalysts may be utilized. The condensation catalyst(s) may be present in an amount of from about 0.01 wt % to about 1.0 wt %, including from about 0.25 wt % to about 8 wt %, based on the total weight of the silane-grafted polyolefin elastomer/blend composition.

In some aspects, a crosslinking system can include and use one or all of a combination of radiation, heat, moisture, and additional condensation catalyst. In some aspects, the condensation catalyst may be present in an amount of from 0.25 wt % to 8 wt %. In other aspects, the condensation catalyst may be included in an amount of from about 1 wt % to about 10 wt % or from about 2 wt % to about 5 wt %.

### Foaming Agent

The foaming agent can be a chemical foaming agent (e.g., organic or inorganic foaming agent) and/or a physical foaming (e.g., gases and volatile low weight molecules) that is added to the silane-grafted polyolefin elastomer and condensation catalyst blend during the extrusion and/or molding process to produce the crosslinked foam polyolefin elastomers.

In some aspects, the foaming agent may be a physical foaming agent including the microencapsulated foaming agent, otherwise referred to in the art as a microencapsulated blowing agent (MEBA). MEBAs include a family of physical foaming agents that are defined as a thermo expandable microsphere which is formed by the encapsulation of a volatile hydrocarbon into an acrylic copolymer shell. When the acrylic copolymer shell expands, the volatile hydrocarbon (e.g., butane) creates a foam in the silane-crosslinkable polyolefin elastomer and reduces its weight. In some aspects, the MEBAs have an average particle size of from about 20 μm to about 30 μm. Exemplary MEBAs include those sold under the trade name MATSUMOTO F-AC170D. In some aspects, MEBA's may be used in combination with other foaming agents including organic and inorganic foaming agents.

In some aspects, the foaming agent may be a combination of endothermic and/or exothermic foaming compounds that can create a cell structure using a water releasing agent to accelerate the curing times, e.g. 40 seconds to 100 seconds, in the mold having a temperature greater than 150° C.

Organic foaming agents that may be used can include, for example, azo compounds, such as azodicarbonamide (ADCA), barium azodicarboxylate, azobisisobutyronitrile (AIBN), azocyclohexylnitrile, and azodiaminobenzene, N-nitroso compounds, such as N,N′-dinitrosopentamethylenetetramine (DPT), N,N′-dimethyl-N,N′-dinitrosoterephthalamide, and trinitrosotrimethyltriamine, hydrazide compounds, such as 4,4′-oxybis(benzenesulfonylhydrazide)(OBSH), paratoluene sulfonylhydrazide, diphenylsulfone-3,3′-disulfonylhydrazide, 2,4-toluenedisulfonylhydrazide, p,p-bis(benzenesulfonylhydrazide)ether, benzene-1,3-disulfonylhydrazide, and allylbis(sulfonylhydrazide), semicarbazide compounds, such as p-toluilenesulfonylsemicarbazide, and 4,4′-oxybis(benzenesulfonylsemicarbazide), alkane fluorides, such as trichloromonofluoromethane, and dichloromonofluoromethane, and triazole compounds, such as 5-morpholyl-1,2,3,4-thiatriazole, and other known organic foaming agents. In some aspects, azo compounds and N-nitroso compounds are used. In other aspects, azodicarbonamide (ADCA) and N,N′-dinitrosopentamethylenetetramine (DPT) are used. The organic foaming agents listed above may be used alone or in any combination of two or more.

The decomposition temperature and amount of organic foaming agent used can have important consequences on the density and material properties of the crosslinked foam polyolefin elastomers. In some aspects, the organic foaming agent has a decomposition temperature of from about 150° C. to about 210° C. The organic foaming agent can be used in an amount of from about 0.1 wt % to about 40 wt %, from about 5 wt % to about 30 wt %, from about 5 wt % to about 20 wt %, from about 10 wt % to about 30 wt %, or from about 1 wt % to about 10 wt % based on the total weight of the polymer blend. If the organic foaming agent has a decomposition temperature lower than 150° C., early foaming may occur during compounding. Meanwhile, if the organic foaming agent has a decomposition temperature higher than 210° C., it may take longer, e.g., greater than 15 minutes, to mold the foam, resulting in low productivity. Additional foaming agents may include any compound whose decomposition temperature is within the range defined above.

The inorganic foaming agents that may be used include, for example, hydrogen carbonate, such as sodium hydrogen carbonate and ammonium hydrogen carbonate; carbonate, such as sodium carbonate and ammonium carbonate; nitrite, such as sodium nitrite and ammonium nitrite; borohydride, such as sodium borohydride; and other known inorganic foaming agents, such as azides. In some aspect, hydrogen carbonate may be used. In other aspects, sodium hydrogen carbonate may be used. The inorganic foaming agents listed above may be used alone or in any combination of two or more. The inorganic foaming agent can be used in an amount of from about 0.1 wt % to about 40 wt %, from about 5 wt % to about 30 wt %, from about 5 wt % to about 20 wt %, from about 10 wt % to about 30 wt %, or from about 1 wt % to about 10 wt % based on the total weight of the polymer blend.

Physical blowing agents that may be used include, for example, supercritical carbon dioxide, supercritical nitrogen, butane, pentane, isopentane, cyclopentane. In some aspects, various minerals or inorganic compounds (e.g., talc and calcium carbonate) may be used as a nucleating agent for the supercritical fluid. The physical foaming agent can be used in an amount of from about 0.1 wt % to about 40 wt %, from about 5 wt % to about 30 wt %, from about 5 wt % to about 20 wt %, from about 10 wt % to about 30 wt %, or from about 1 wt % to about 10 wt % based the total weight of the polymer blend.

### Optional Additional Components

The crosslinked foam polyolefin elastomers may optionally include one or more fillers.

The filler(s) may be extruded with the silane-grafted polyolefin. In some aspects, the filler(s) may include metal oxides, metal hydroxides, metal carbonates, metal sulfates, metal silicates, clays, talcs, carbon black, and silicas. Depending on the application and/or desired properties, these materials may be fumed or calcined.

With further regard to the optional fillers, the metal of the metal oxide, metal hydroxide, metal carbonate, metal sulfate, or metal silicate may be selected from alkali metals (e.g., lithium, sodium, potassium, rubidium, caesium, and francium); alkaline earth metals (e.g., beryllium, magnesium, calcium, strontium, barium, and radium); transition metals (e.g., zinc, molybdenum, cadmium, scandium, titanium, vanadium, chromium, manganese, iron, cobalt, nickel, copper, yttrium, zirconium, niobium, technetium, ruthernium, rhodium, palladium, silver, hafnium, taltalum, tungsten, rhenium, osmium, indium, platinum, gold, mercury, rutherfordium, dubnium, seaborgium, bohrium, hassium, and copernicium); post-transition metals (e.g., aluminum, gallium, indium, tin, thallium, lead, bismuth, and polonium); lanthanides (e.g., lanthanum, cerium, praseodymium, neodymium, promethium, samarium, europium, gadolinium, terbium, dysprosium, holmium, erbium, thulium, ytterbium, and lutetium); actinides (e.g., actinium, thorium, protactinium, uranium, neptunium, plutonium, americium, curium, berkelium, californium, einsteinium, fermium, mendelevium, nobelium, and lawrencium); germanium; arsenic; antimony; and astatine.

The filler(s) of the crosslinked foam polyolefin elastomers or blend may be present in an amount of from greater than 0 wt % to about 50 wt %, including from about 1 wt % to about 20 wt %, and from about 3 wt % to about 10 wt %.

The crosslinked foam polyolefin elastomers and/or the respective articles formed (e.g., midsole 18) may also include waxes (e.g., paraffin waxes, microcrystalline waxes, HDPE waxes, LDPE waxes, thermally degraded waxes, byproduct polyethylene waxes, optionally oxidized Fischer-Tropsch waxes, and functionalized waxes). In some embodiments, the wax(es) are present in an amount of from about 0 wt % to about 10 wt %.

Tackifying resins (e.g., aliphatic hydrocarbons, aromatic hydrocarbons, modified hydrocarbons, terpens, modified terpenes, hydrogenated terpenes, rosins, rosin derivatives, hydrogenated rosins, and mixtures thereof) may also be included in the silane-crosslinker polyolefin elastomer/blend. The tackifying resins may have a ring and ball softening point in the range of from 70° C. to about 150° C. and a viscosity of less than about 3,000 cP at 177° C. In some aspects, the tackifying resin(s) are present in an amount of from about 0 wt % to about 10 wt %.

In some aspects, the crosslinked foam polyolefin elastomers may include one or more oils. Non-limiting types of oils include white mineral oils and naphthenic oils. In some embodiments, the oil(s) are present in an amount of from about 0 wt % to about 10 wt %.

### Method for Making the Crosslinked Foam Polyolefin Elastomers

The synthesis/production of the reagent silane-grafted polyolefin elastomers may be performed as described in the grafting steps outlined using the single-step Monosil process or the two-step Sioplas process as disclosed in U.S. patent application Ser. No. 15/836,436, filed Dec. 8, 2017, entitled “SHOE SOLES, COMPOSITIONS, AND METHODS OF MAKING THE SAME” which is herein incorporated by reference in its entirety.

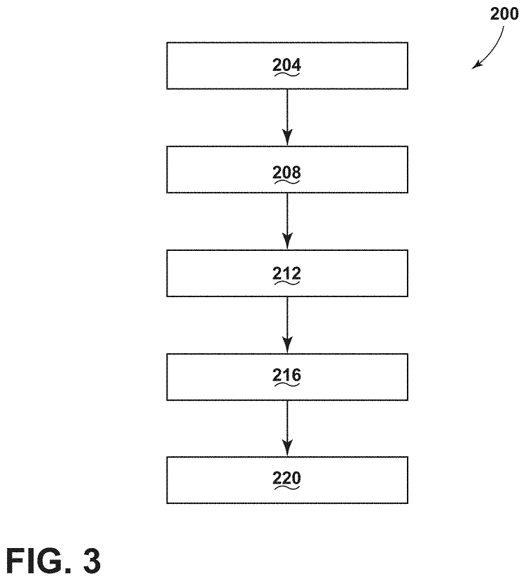

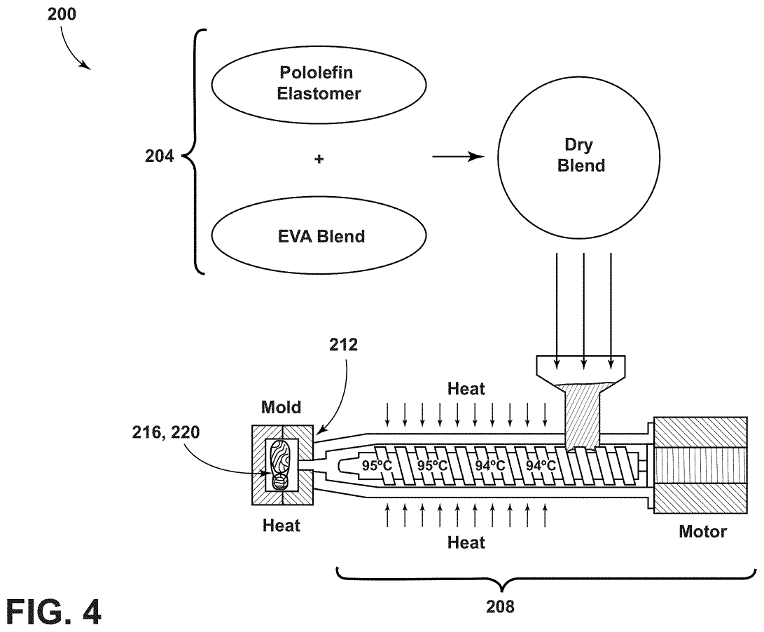

According FIGS. 3 and 4, a method 200 for making a shoe sole is provided. The method 200 includes a step 204 of mixing a silane-grafted polyolefin, an ethylene vinyl acetate (EVA) copolymer, a crosslinker, a foaming agent, and a condensation catalyst together to form a dry mix. The dry mix may exist in a stable or unreactive form until it is heated to activate the crosslinker, foaming agent, and/or condensation catalyst.

Next is a step 208 of extruding the silane-grafted polyolefin, the ethylene vinyl acetate (EVA) copolymer, the crosslinker, the foaming agent, and the condensation catalyst together to form a crosslinkable polyolefin blend.

Next is a step 212 of injection molding the crosslinkable polyolefin blend into a shoe sole element. Following the injection step, a step 216 of crosslinking the crosslinkable polyolefin blend of the shoe sole element using a dual crosslinking system to form silane graft-silane graft crosslinks, silane graft-carbon crosslinks, and/or carbon-carbon crosslinks at a temperature greater than 150° C. to form a shoe sole having a density less than 0.50 g/cm³.

Lastly or intermittedly is a step 216 of catalyzing the dual crosslinking system of the crosslinking step by generating acetic acid in situ from the ethylene vinyl acetate (EVA) copolymer. In some aspects, the shoe sole can exhibit a compression set of from about 1.0% to about 50.0%, as measured according to ASTM D 395 (48 hrs @ 50° C.) and has a density less than 0.88 g/cm³.

It is understood that the description outlining and teaching the crosslinked foam polyolefin elastomer previously discussed, which can be used in any combination or formulation, applies equally well to the method 200 for making a shoe sole.

Referring to FIG. 4, a dry blend may be formed by adding a polyolefin elastomer to an EVA blend. In some aspects, the dry blend may include from about 10% to about 90%, from about 20% to about 80%, from about 20% to about 60%,from about 40% to about 80% or from about 60% to about 80% polyolefin elastomer. The dry blend may additionally include and from about 10% to about 90%, from about 20% to about 80%, from about 20% to about 60%, from about 40% to about 80% or from about 60% to about 80% EVA blend. The EVA blend may include EVA, the crosslinker, the condensation catalyst, and/or the foaming agent.

### Molding Techniques

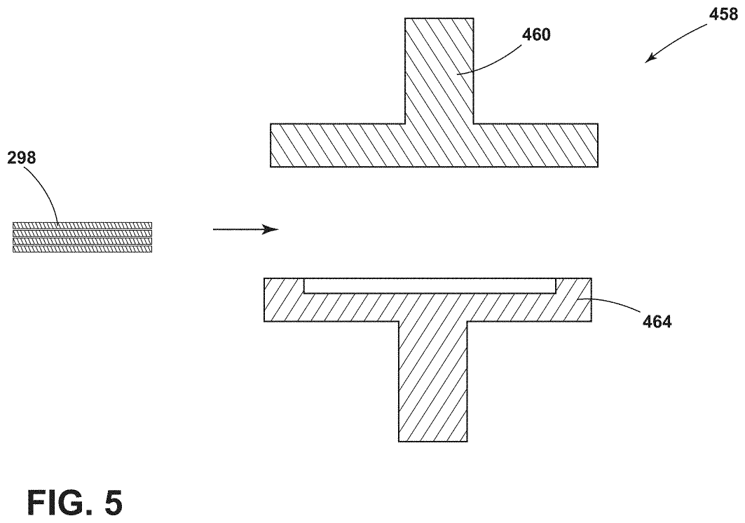

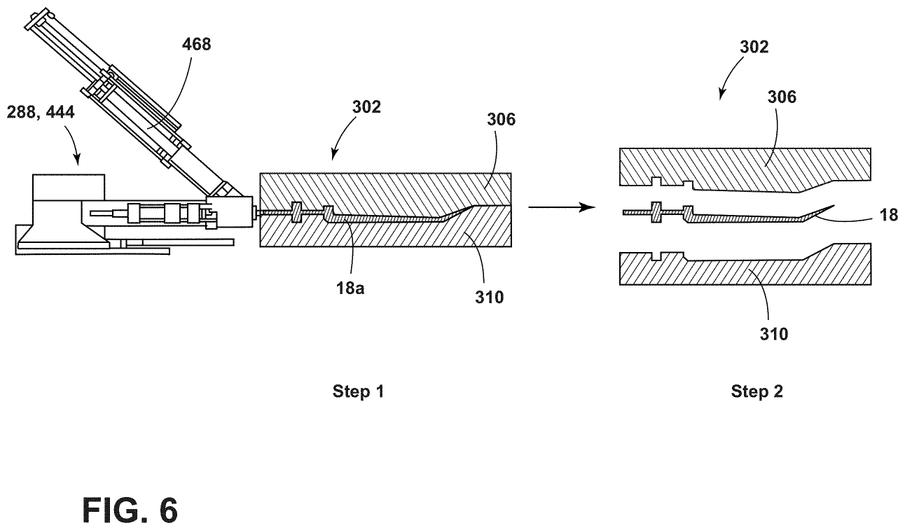

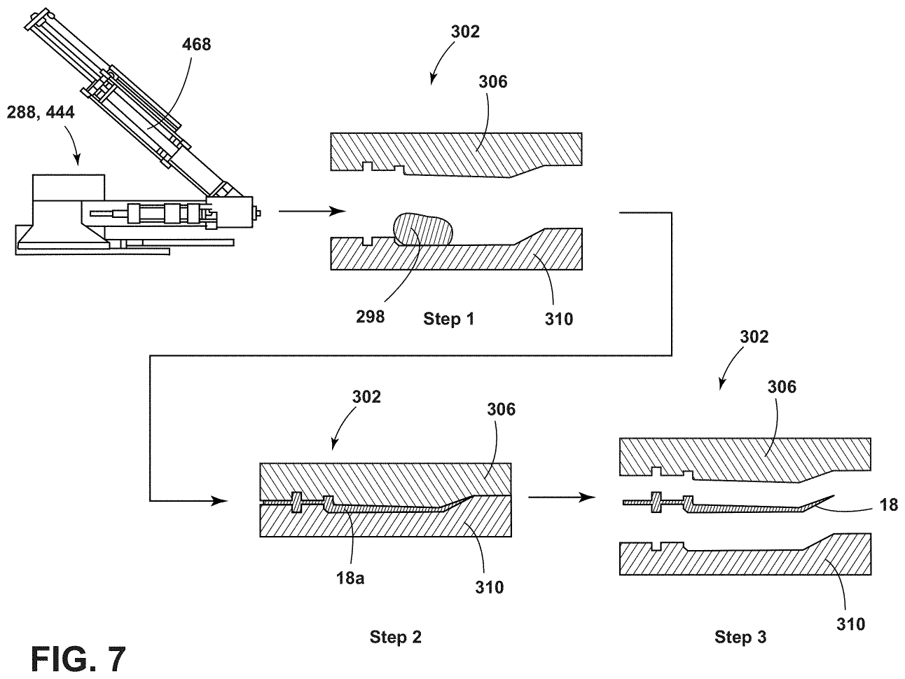

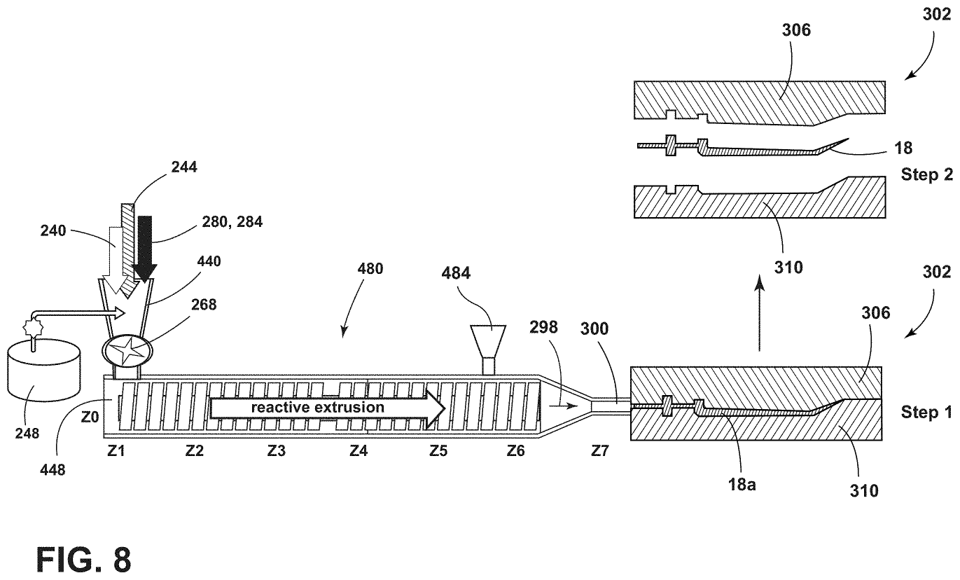

Injecting or adding the silane-crosslinkable polyolefin elastomer blend 298 into the shoe sole mold 302 to form a shoe sole element 314 (see FIG. 4) may be performed using one of several different approaches. Depending on the molding approach selected, different material properties may be achieved for the midsole 18. The molding can be performed by using one of the four following processes: Compression Molding (FIG. 5), Injection Molding (FIG. 6), Injection Compression Molding (FIG. 7), and Supercritical Injection Molding (FIG. 8).

Referring to FIG. 5, a schematic cross-sectional view of a compression mold 458 is provided. According to the compression mold process, the silane-crosslinkable polyolefin elastomer 298 (or shoe sole element 314, not shown) is pressurized in the compression mold or press 458 under predetermined temperature, pressure, and time conditions to obtain a crosslinked foam polyolefin elastomers in the form of a plate-like sponge (not shown). The compression mold 458 includes an upper mold 460 and a lower mold 464. As the silane-crosslinkable polyolefin elastomer 298 is heated and pressed in the compression mold 458, the chemical and/or physical foaming agents are activated to form the crosslinked foam polyolefin elastomers. Portions and/or edges of plate-like sponge may then be skived, cut, and/or ground into a midsole 18 having a desired thickness and shape (see FIGS. 1-2). Subsequently, the midsole 18 is again molded in a final mold with the outsole 14 and other respective components under heat and pressure and the assembly is then pressurized during cooling in a closed state of the mold (this process is called “phylon molding” in the shoe industry) to produce a final shoe sole (e.g., shoe sole 10).

Referring now to FIG. 6, a schematic cross-sectional view of an injection mold is provided. According to the injection molding process, the reactive single screw extruder 288, 444 used in either the Sioplas or Monosil process prepares and injects the silane-crosslinkable polyolefin elastomer 298 into the mold 302 having an upper mold 306 and a lower mold 310. Upon initial injection of the silane-crosslinkable polyolefin elastomer 298 into the mold 302, an uncured midsole 18a is formed as provided in step 1 of FIG. 6. As the uncured midsole 18a is heated and cured, the chemical and/or physical foaming agents are activated to form the crosslinked foam polyolefin elastomers. The mold 302 used in these aspects is designed to have a smaller size than the size of the final cured midsole 18 (crosslinked foam polyolefin elastomers). After foaming and expansion of the silane-crosslinkable polyolefin elastomer, the uncured midsole 18a is expanded to the desired size of the midsole 18 and the mold 302 releases as provided in step 2 of FIG. 6.

Referring to FIG. 7, a schematic cross-sectional view of an injection compression mold is provided. The injection compression mold provides a hybrid approach to forming the midsole 18 by using aspects of both the compression mold described in FIG. 5 and the injection mold described in FIG. 6. According to the injection compression process, the reactive single screw extruder 288, 444 used in either the Sioplas or Monosil process prepares and injects a mass of the silane-crosslinkable polyolefin elastomer 298 into the mold 302 having an upper mold 306 and a lower mold 310 as provided in step 1 of FIG. 7. The mass of silane-crosslinkable polyolefin elastomer 298 is then heated and pressed in the mold 302 to form the uncured midsole 18a while the chemical and/or physical foaming agents are activated to form the crosslinked foam polyolefin elastomers making up the final cured midsole 18 as provided in step 2 of FIG. 7. The mold 302 used in these injection compression processes is designed to have a smaller size than the size of the final cured midsole 18 (crosslinked foam polyolefin elastomers). After foaming and expansion of the silane-crosslinked polyolefin elastomer, the mold 302 is released to eject the final cured midsole 18 as provided in step 3 of FIG. 7.

Referring now to FIG. 8, a schematic cross-sectional view of a reactive single screw extruder 480 equipped with a supercritical fluid injector 484 is provided. The process begins by extruding (e.g., with the reactive single screw extruder 480) the first polyolefin 240 having a density less than 0.86 g/cm³, the second polyolefin 244, the silan cocktail 248 including the silane crosslinker (e.g., vinyltrimethoxy silane, VTMO and/or vinyltriethoxy silane, VTEO), grafting initiator (e.g. dicumyl peroxide), and the condensation catalyst 280 together to form the crosslinkable silane-grafted polyolefin blend 298. The first polyolefin 240, second polyolefin 244, and silan cocktail 248 may be added to the reactive single screw extruder 480 using an addition hopper 440 and gear pump 268. In some aspects, the silan cocktail 248 may be added to a single screw 448 further down the extrusion line to help promote better mixing with the first and second polyolefin 240, 244 blend. In some aspects, one or more optional additives 284 may be added with the first polyolefin 240, second polyolefin 244, and silan cocktail 248 to tweak the final material properties of the silane-crosslinkable polyolefin blend 298.

Still referring to FIG. 8, the supercritical fluid injector 484 may be used to add a supercritical fluid such as carbon dioxide or nitrogen to the silane-crosslinkable polyolefin blend 298 before it is injected through the die 300 into the mold 302. The reactive single screw extruder 480 then injects the silane-crosslinkable polyolefin elastomer 298 into the mold 302 having an upper mold 306 and a lower mold 310. Upon initial injection of the silane-crosslinkable polyolefin elastomer 298 into the mold 302, an uncured midsole 18a is formed as provided in step 1 of FIG. 8. As the uncured midsole 18a is heated and cured, the supercritical fluid foaming agent expands to form the crosslinked foam polyolefin elastomers. The mold 302 used in these aspects is designed to have a smaller size than the size of the final cured midsole 18 (crosslinked foam polyolefin elastomers). After foaming, the crosslinked foam polyolefin elastomers is expanded to the desired size of the midsole 18 using core pull back to accommodate the expansion, and the mold releases as provided in step 2 of FIG. 8.

### Crosslinked Foam Polyolefin Elastomers Physical Properties

The use of the crosslinker with the silane-grafted polyolefin to provide the dual crosslinking system provides a crosslinked foam polyolefin article that can have ideal properties for numerous polymer foam applications. For example, the crosslinked foam polyolefin article may have a low specific gravity or density that makes the foam material light weight, soft, and comfortable for use as a shoe sole, sole liner, insole, mid sole, and/or outer sole. The crosslinked network of the crosslinked foam polyolefin article can also increase/improve the foam article's stability, rebound energy, and resilience. Lastly, the crosslinked network of the crosslinked foam polyolefin article provides a reduced dynamic compression set resulting in improved longevity.

In addition, the network architecture of the crosslinked foam polyolefin article provides temperature independent stiffness and a high energy return. The network architecture helps ensure a broad temperature resistance. A low glass transition temperature guarantees a broad temperature resistance and short chain branching POE and OBC foams recover faster than highly branched EVA. In some aspects, the random orientation and positioning of the ethylene co-polymers provide flexibility and softness.

A “thermoplastic”, as used herein, is defined to mean a polymer that softens when exposed to heat and returns to its original condition when cooled to room temperature. A “thermoset”, as used herein, is defined to mean a polymer that solidifies and irreversibly “sets” or “crosslinks” when cured. In either of the Monosil or Sioplas processes described above, it is important to understand the careful balance of thermoplastic and thermoset properties of the various different materials used to produce the final thermoset crosslinked foam polyolefin elastomers or midsole 18. Each of the intermediate polymer materials mixed and reacted using a reactive twin screw extruder, a non-reactive single screw extruder, and a reactive single screw extruder are thermosets. Accordingly, the silane-grafted polyolefin blend and the silane-crosslinkable polyolefin blend are thermoplastics and can be softened by heating so the respective materials can flow. Once the silane-crosslinkable polyolefin blend is extruded, molded, pressed, and/or shaped into the shoe sole mold 302 or other respective article, the silane-crosslinkable polyolefin blend can begin to crosslink or cure at a temperature greater than 150° C. and an ambient humidity to form the midsole 18 and crosslinked foam polyolefin elastomers blend. At temperatures greater than 150° C., the silane-crosslinkable polyolefin blend can be foamed and crosslinked in a molding time from 40 seconds to 400 seconds, from 40 seconds to 200 seconds, from 40 seconds to 100 seconds, or in about 60 seconds.

The thermoplastic/thermoset behavior of the silane-crosslinkable polyolefin blend and corresponding crosslinked foam polyolefin elastomers blend are important for the various compositions and articles disclosed herein (e.g., midsole 18 shown in FIG. 1) because of the potential energy savings provided using these materials. For example, a manufacturer can save considerable amounts of energy by being able to cure the silane-crosslinkable polyolefin blend at a temperature greater than 150° C. and an ambient humidity. This curing process is typically performed in the industry by applying significant amounts of energy to heat or steam treat crosslinkable polyolefins. The ability to cure the inventive silane-crosslinkable polyolefin blend with a lower relative temperature and/or ambient humidity or by shortening the cure time at elevated temperatures are not properties necessarily intrinsic to crosslinkable polyolefins. Rather, this temperature/humidity curing capability is a property dependent on the relatively low density of the silane-crosslinkable polyolefin blend. In some aspects, no additional curing ovens, heating ovens, steam ovens, or other forms of heat producing machinery other than what was provided in the extruders are used to form the crosslinked foam polyolefin elastomers.

The specific gravity of the crosslinked foam polyolefin elastomers of the present disclosure may be lower than the specific gravities of existing TPV and EPDM formulations used in the art. The reduced specific gravity of these materials can lead to lower weight shoes, thereby helping shoe manufacturers meet increasing demands for lighter weight shoes. For example, the specific gravity of the crosslinked foam polyolefin elastomers of the present disclosure may be from about 0.10 g/cm³ to about 0.50 g/cm³, from about 0.15 g/cm³ to about 0.50 g/cm³, from about 0.15 g/cm³ to about 0.40 g/cm³, from about 0.15 g/cm³ to about 0.35 g/cm³, from about 0.20 g/cm³ to about 0.40 g/cm³, from about 0.20 g/cm³ to about 0.45 g/cm³, from about 0.25 g/cm³ to about 0.35 g/cm³, from about 0.30 g/cm³ to about 0.50 g/cm³, from about 0.30 g/cm³ to about 0.40 g/cm³, from about 0.35 g/cm³ to about 0.50 g/cm³, from about 0.35 g/cm³ to about 0.40 g/cm³, about 0.50 g/cm³, about 0.45 g/cm³, about 0.40 g/cm³, about 0.35 g/cm³, about 0.30 g/cm³, about 0.25 g/cm³, about 0.20 g/cm³, or about 0.15 g/cm³ as compared to existing TPO materials which may have a specific gravity greater than 0.35 g/cm³ or greater than 0.40 g/cm³. In some aspects, the specific gravity may be less than about 0.50 g/cm³, less than about 0.45 g/cm³, less than about 0.40 g/cm³, less than about 0.35 g/cm³, less than about 0.30 g/cm³, less than about 0.25 g/cm³, less than about 0.20 g/cm³, or less than about 0.15 g/cm³

The crosslinked foam polyolefin elastomers may be produced as a closed celled foam.

The pore size of the crosslinked foam polyolefin elastomers may be from about 0.10 mm to about 0.50 mm, from about 0.10 mm to about 0.40 mm, from about 0.10 mm to about 0.30 mm, from about 0.10 mm to about 0.25 mm, from about 0.10 mm to about 0.50 mm, or about 0.10 mm, about 0.12 mm, about 0.14 mm, about 0.16 mm, about 0.18 mm, about 0.20 mm, about 0.22 mm, about 0.24 mm, about 0.26 mm, about 0.28 mm, or about 0.30 mm.

The stress/strain behavior of an exemplary crosslinked foam polyolefin elastomers of the present disclosure (i.e., “crosslinked foam polyolefin elastomers”) relative to two conventional EPDM materials has been observed. A smaller area exists between the stress/strain curves for the crosslinked foam polyolefin elastomers of the disclosure, as compared to the areas between the stress/strain curves for the two EPDM materials. This smaller area between the stress/strain curves for the crosslinked foam polyolefin elastomers can be desirable for midsoles. Elastomeric materials typically have non-linear stress-strain curves with a significant loss of energy when repeatedly stressed. The crosslinked foam polyolefin elastomers of the present disclosure may exhibit greater elasticity and less viscoelasticity (e.g., they have linear curves and exhibit very low energy loss). Embodiments of the crosslinked foam polyolefin elastomers described herein do not have any filler or plasticizer incorporated into these materials so their corresponding stress/strain curves do not have or display any Mullins effect and/or Payne effect. The lack of Mullins effect for these crosslinked foam polyolefin elastomers is due to the lack of any filler or plasticizer added to the crosslinked foam polyolefin elastomers blend so the stress/strain curve does not depend on the maximum loading previously encountered where there is no instantaneous and irreversible softening. The lack of Payne effect for these crosslinked foam polyolefin elastomers is due to the lack of any filler or plasticizer added to the crosslinked foam polyolefin elastomers blend so the stress/strain curve does not depend on the small strain amplitudes previously encountered where there is no change in the viscoelastic storage modulus based on the amplitude of the strain.

The crosslinked foam polyolefin elastomers or midsole 18 can exhibit a compression set of from about 1.0% to about 50.0%, from about 5.0% to about 50.0%, from about 1.0% to about 40.0%, from about 5.0% to about 40.0%, from about 5.0% to about 30.0%, from about 5.0% to about 25.0%, from about 5.0% to about 20.0%, from about 5.0% to about 15.0%, from about 5.0% to about 10.0%, from about 10.0% to about 25.0%, from about 10.0% to about 20.0%, from about 10.0% to about 15.0%, from about 15.0% to about 30.0%, from about 15.0% to about 25.0%, from about 15.0% to about 20.0%, from about 20.0% to about 30.0%, or from about 20.0% to about 25.0%, from about 1.0% to about 40.0%, as measured according to ASTM D 395 (48 hrs @ 23° C., 50° C., 70° C., 80° C., 90° C., 125° C., and/or 175° C.).

In other implementations, the crosslinked foam polyolefin elastomers or midsole 18 can exhibit a compression set of from about 5.0% to about 20.0%, from about 5.0% to about 15.0%, from about 5.0% to about 10.0%, from about 7.0% to about 20.0%, from about 7.0% to about 15.0%, from about 7.0% to about 10.0%, from about 9.0% to about 20.0%, from about 9.0% to about 15.0%, from about 9.0% to about 10.0%, from about 10.0% to about 20.0%, from about 10.0% to about 15.0%, from about 12.0% to about 20.0%, or from about 12.0% to about 15.0%, from about 1.0% to about 50.0%, as measured according to ASTM D 395 (48 hrs @ 23° C., 50° C., 70° C., 80° C., 90° C., 125° C., and/or 175° C.).

The crosslinked foam polyolefin elastomers or midsole 18 may exhibit a crystallinity of from about 5% to about 40%, from about 5% to about 25%, from about 5% to about 15%, from about 10% to about 20%, from about 10% to about 15%, or from about 11% to about 14% as determined using density measurements, differential scanning calorimetry (DSC), X-Ray Diffraction, infrared spectroscopy, and/or solid state nuclear magnetic spectroscopy.

The crosslinked foam polyolefin elastomers or midsole 18 may exhibit a glass transition temperature of from about −75° C. to about −25° C., from about −65° C. to about −40° C., from about −60° C. to about −50° C., from about −50° C. to about −25° C., from about −50° C. to about −30° C., or from about −45° C. to about −25° C. as measured according to differential scanning calorimetry (DSC) using a second heating run at a rate of 5° C./min or 10° C./min.

The crosslinked foam polyolefin elastomers or midsole 18 may exhibit a rebound resilience of at least 10%, at least 20%, at least 30%, at least 40%, at least 50%, at least 60%, at least 70%, at least 80%, or at least 90%.

### EXAMPLES

The following examples represent certain non-limiting examples of the shoe soles, compositions and methods of making them, according to the disclosure.

### Materials

All chemicals, precursors and other constituents were obtained from commercial suppliers and used as provided without further purification.

### Comparative Examples

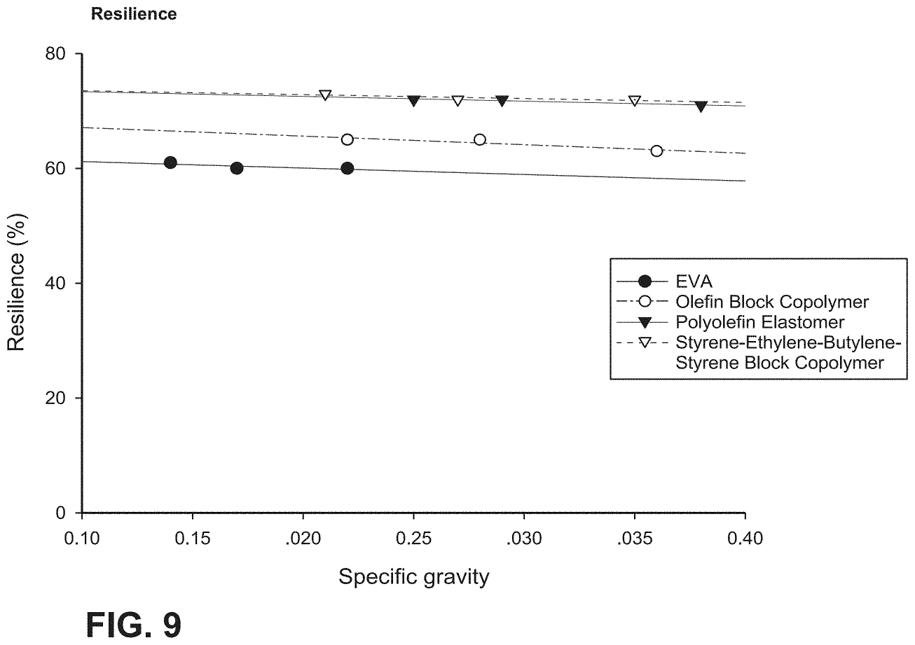

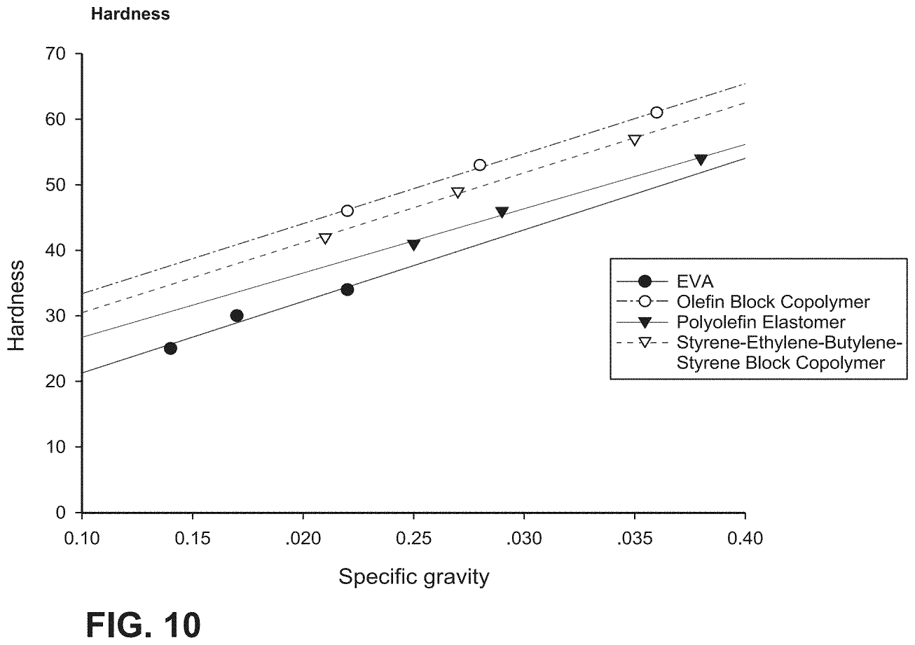

Referring to FIGS. 9 and 10, a resilience versus specific gravity plot and a hardness versus specific gravity plot for a variety of crosslinked materials, respectively, are provided according to some aspects of the present disclosure. Of the four materials measured and plotted in FIG. 9, it is noted that the inventive crosslinked and foamed polyolefin elastomer (DF 605) demonstrated similar elevated resilience (greater than 70%) as the styrene-ethylene-butylene-styrene (SEBS)(P1083) while The EVA (Elvax 40L03) and olefin block copolymer (OBC)(Infuse 9107) provide resilience over 60%. Related to resilience, the same four materials were measured and plotted with respect to hardness in FIG. 10. The inventive crosslinked and foamed polyolefin elastomer (DF 605) demonstrated similar elevated hardness (greater than 30 with a positive slope) as the styrene-ethylene-butylene-styrene (SEBS)(P1083) while The EVA (Elvax 40L03) and olefin block copolymer (OBC)(Infuse 9107) provide resilience over 60%. Nike has previously described a family of styrene-ethylene-butylene-styrene (SEBS)(P1083) as disclosed in U.S. patent application Ser. No. 15/458,332, filed Mar. 14, 2017, entitled “FOAM COMPOSITIONS AND USES THEREOF” which is herein incorporated by reference in its entirety.

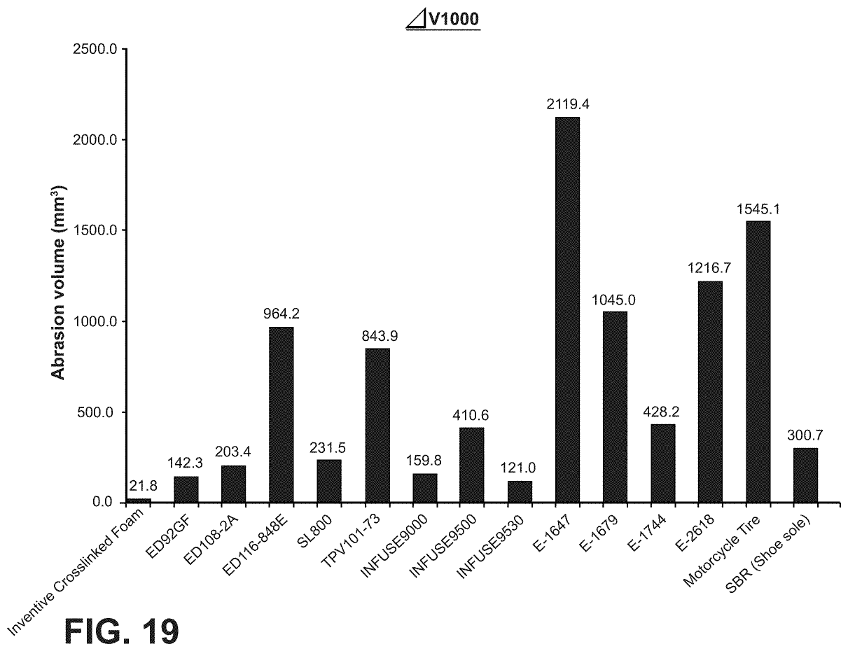

Referring now to FIG. 19, a graph depicting volume loss over 1000 cycles for a variety of crosslinked foamed polyolefin elastomers according to some aspects of the present disclosure is provided. As illustrated and expected with the corresponding crosslink density, the first listed inventive crosslinked foam material provides the least amount of volume loss. A shoe sole or foam article that maintains its volume over extended period of time and use would be expected to be a more reliable material than the other listed comparative foams that shrink or have their porous cell structure deteriorated.

### Examples 1-4

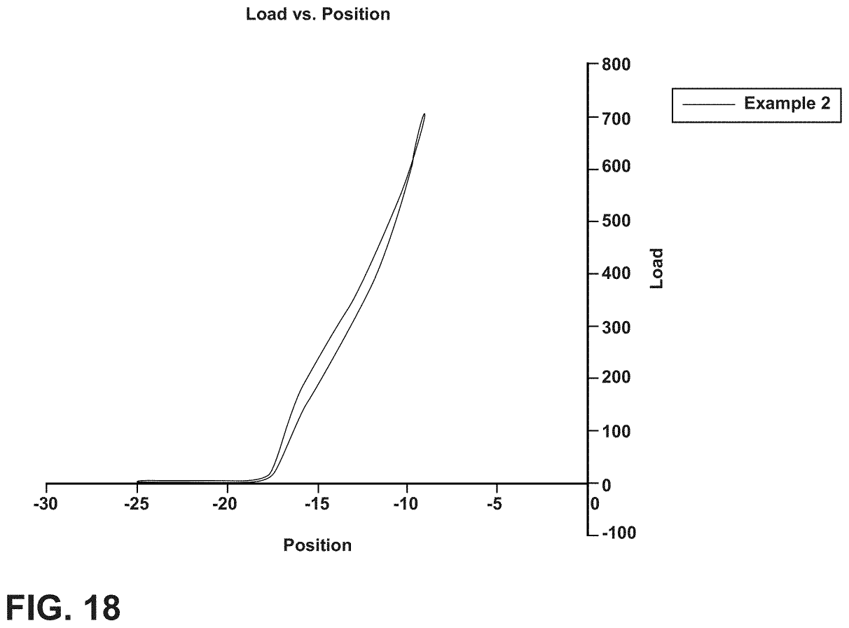

A foamed midsole was prepared by dry blending or mixing the various components together and using a compression molding system at 170° C. for 480 seconds to form Examples 1, 2, 3, and 4. The components used in Examples 1-4 are listed below in Table 1 and include a polyolefin elastomer (R3) and/or a silane-grafted polyolefin elastomer having vinyltrimethoxy silane incorporated (MSX-041). The compression molding system was then used to mix and mold the Example 1-4 compositions. The measured Density, ER %, Hardness (C type), Resilience, Compression Set, Split, and T-shrinkage values for the corresponding crosslinked foam polyolefin elastomers in Examples 1-4 are additionally provided in Table 1. FIG. 18 is a load versus position plot of the inventive Example 2 crosslinked foamed polyolefin elastomer. The small gap formed between the plot lines as a load is applied and removed from the Example 2 foam illustrated that minimal energy is lost as the load is deflected by the foam providing an excellent example of energy being returned to the system.

TABLE 1

| | Example 1 | Example 2 | Example 3 | Example 4 | Test Method |
|---|---|---|---|---|---|
| R3 | 100 | 90 | 80 | 70 | |
| MSX-041 | — | 10 | 20 | 30 | |

Compression molding: 170° C. × 480 sec [10 mm mold]

| | | | | | |
|---|---|---|---|---|---|
| ER % | 154 | 147 | 141 | 136 | |
| Sp. Gr. | 0.20 | 0.21 | 0.24 | 0.26 | ASTM |
| | | | | | D 297 |
| Hd | 33 | 35 | 39 | 44 | ASTM |
| (C type) | | | | | D 2240 |
| Resilience | 75 | 74 | 72 | 69 | KS M |
| (%) | | | | | ISO 8307 |
| C/set (%) | 45 | 50 | 56 | 60 | ASTM |
| | | | | | D 395 |
| Split | 2.2 | 2.5 | 2.7 | 2.8 | ASTM |
| (kg/com) | | | | | D 3574 |
| T-shrinkage | 5.3 | 3.8 | 3.2 | 2.4 | 70° C., |
| (%) | | | | | 30 min |

### Examples 6-11

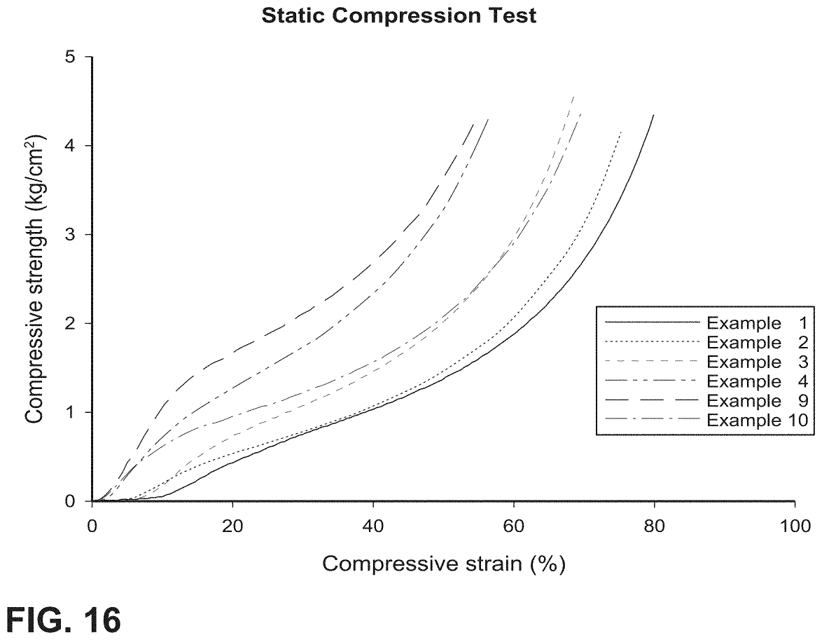

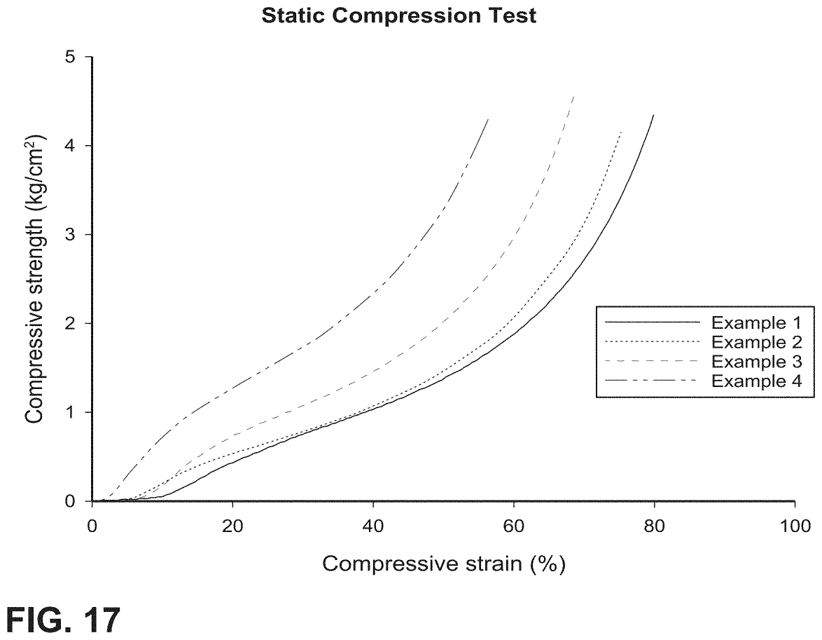

A foamed midsole was prepared by dry blending or mixing the various components together and using an injection molding system at 190° C. for 360 seconds to form Examples 6-11. The components used in Examples 6-11 are listed below in Table 2 and include a silane-grafted polyolefin elastomer having vinyltrimethoxy silane (VTMO) incorporated (MSX-041), a silane-grafted polyolefin elastomer having vinyltriethoxy silane (VTEO) incorporated (MSX-042), an ethylene vinyl acetate copolymer (SD-23), and/or a blowing agent such as azodicarbonamide (ADCA) listed as JTR-TL. The injection molding system was then used to inject the mixed Example 6-11 compositions. The measured Density, Expansion Ratio A/B direction (ER %), Hardness (C type), Resilience, Compression Set, Split Tear, and T-shrinkage values for the corresponding crosslinked foam polyolefin elastomers in Examples 6-11 are additionally provided in Table 2. FIGS. 16 and 17 are static compression plots providing compressive strength versus compressive strain for a variety of crosslinked foamed polyolefin elastomers provided in Tables 1 and 2.

TABLE 2

| | Example | Example | Example | Example | Example | Example | Test |
|---|---|---|---|---|---|---|---|
| | 6 | 7 | 8 | 9 | 10 | 11 | Method |
| MSX 041 | 70 | 70 | 70 | — | — | — | |
| MSX 042 | — | — | — | 70 | 70 | 70 | |
| SD-23 | 30 | 30 | 30 | 30 | 30 | 30 | |
| JTR/TL | — | 3 | 5 | — | 3 | 5 | |

Properties

| | | | | | | | |
|---|---|---|---|---|---|---|---|
| Expansion | Low gas | 154/158 | CC | 142/43 | 161/164 | 172/178 | — |
| Ratio A/B % | pressure | | | | | | |
| Specific | | 0.20 | | 0.27 | 0.17 | 0.14 | ASTM D 2240 |
| Gravity | | | | | | | |
| Hardness | | 44 | | 47 | 35 | 30 | ASTM D 297 |
| Resilience | | 66 | | 62 | 66 | 68 | ASTM D 395 |
| (%) | | | | | | | |
| Compression | | 49 | | 56 | 62 | 65 | KS M ISO |
| Set (%) | | | | | | | 8307 |
| Split tear | | 1.5 | | 2.5 | 1.3 | 0.9 | ASTM D 3574 |
| (Kg/cm) | | | | | | | |
| Akron | | — | | 0.95 | 0.36 | 1.32 | 15°, 6 pound |
| (cc loss) | | | | | | | 3,000 cycles |

CC: Cell collapse by over cure or excessive gas pressure
Examples 6 and 7: pin-hole, Examples 9 and 10: forwarded samples
Compression Set: 50° C., 6 hr, 50% compression
Resilience: Ball drop method

### Examples 12-17

A foamed midsole was prepared by dry blending or mixing the various components together and using an injection molding system at 190° C. for 360 seconds to form Examples 12-17. The components used in Examples 12-17 are listed below in Table 3 and include a silane-grafted polyolefin elastomer having vinyltrimethoxy silane (VTMO) incorporated (MSX-041), a silane-grafted polyolefin elastomer having vinyltriethoxy silane (VTEO) incorporated (MSX-042), an ethylene vinyl acetate copolymer having silicone oil (SD-24), and/or a blowing agent such as azodicarbonamide (ADCA) listed below as JTR-TL. The injection molding system was then used to inject the mixed Example 12-17. The measured Density, Expansion Ratio A/B direction (ER %), Hardness (C type), Resilience, Compression Set, Split Tear, and T-shrinkage values for the corresponding crosslinked foam polyolefin elastomers in Examples 12-17 are additionally provided in Table 3.

TABLE 3

| | Example | Example | Example | Example | Example | Example | TEST |
|---|---|---|---|---|---|---|---|
| | 12 | 13 | 14 | 15 | 16 | 17 | METHOD |
| MSX 041 | 70 | 70 | 70 | — | — | — | |
| MSX 042 | — | — | — | 70 | 70 | 70 | |
| SD-24 | 30 | 30 | 30 | 30 | 30 | 30 | |
| JTR/TL | — | 3 | 5 | — | 3 | 5 | |

Properties

| | | | | | | | |
|---|---|---|---|---|---|---|---|
| Expansion | 142/143 | 155/158 | CC | Not | 160/164 | 171/176 | — |
| Ratio A/B | | | | Manufactured | | | |
| direction (%) | | | | | | | |
| Specific | 0.27 | 0.20 | | | 0.17 | 0.14 | ASTM D |
| Gravity | | | | | | | 2240 |
| Hardness | 47 | 41 | | | 35 | 32 | ASTM D |
| | | | | | | | 297 |
| Resilience | 62 | 66 | | | 65 | 67 | ASTM D |
| (%) | | | | | | | 395 |
| Compression | 56 | 54 | | | 62 | 61 | KS M ISO |
| Set (%) | | | | | | | 8307 |
| Split tear | — | 1.4 | | | 1.3 | 1.1 | ASTM D |
| (Kg/cm) | | | | | | | 3574 |
| Akron | 0.20 | 0.08 | | | 0.22 | 0.11 | 15°, |
| (cc loss) | | | | | | | 6 pound |
| | | | | | | | 3,000 |
| | | | | | | | cycles |

CC: Cell collapse by over cure or excessive gas pressure
Example 11: Sample Preparation by 12.5T mold
Compression Set: 50° C., 6 hr, 50% compression
Resilience: Ball drop method

### Examples 18-19

A foamed midsole was prepared by dry blending or mixing the various components together and using an injection molding system at 190 ° C. for various times to form Examples 18-19. The components used in Examples 18-19 are listed below in Table 4 and include a silane-grafted polyolefin elastomer having vinyltrimethoxy silane (VTMO) incorporated (MSX-041), an ethylene vinyl acetate copolymer having silicone oil (SD-24), and/or a blowing agent such as azodicarbonamide (ADCA) listed below as JTR-TL. The injection molding system was then used to inject the mixed Example 18-19 compositions. The measured Density, Expansion Ratio A/B direction (ER %), Hardness (C type), Resilience, Compression Set, Split Tear, and T-shrinkage values for the corresponding crosslinked foam polyolefin elastomers in Examples 18-19 are additionally provided in Table 4.

TABLE 4

| | Example 18 | Example 19 |
|---|---|---|
| MSX 041 | 60 | 60 |
| MSX 042 | — | — |
| SD-24 | 40 | 40 |
| JTR/TL | 1 | 2 |
| Molding | 240 | 180 |
| time (sec) | | |
| Expansion | 137/136 | 144/143 |
| Ratio A/B | | |
| direction (%) | | |
| Specific | 0.28 | 0.23 |
| Gravity | | |
| Hardness | 53 C | 49 C |
| Resilience | 62 | 65 |
| (%) | | |
| Compression | 35 | 48 |
| Set (%) | | |
| Split tear | 2.2 | 1.8 |
| (Kg/cm) | | |

Compression Set: 50° C., 6 hr, 50% compression
Resilience: Ball drop method

### Example 20

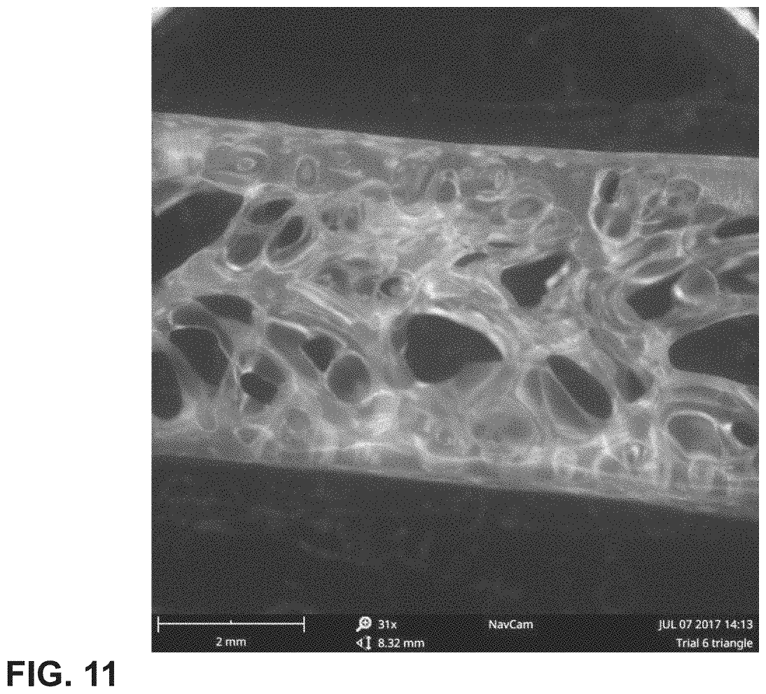

A foamed midsole was prepared using a reactive twin-screw extruder to extrude 60 wt % INFUSE 9530, 30 wt % INFUSE 9817, and 8 wt % PP MI 25 (Polypropylene having a melt index of 25) together with 2.0 wt % SILAN RHS 14/032 or SILFIN 29 to form the RH 17/021 silane-grafted polyolefin elastomer. Next, a reactive single screw extruder equipped with the supercritical fluid injector was employed to further process the blend, where the supercritical fluid medium was nitrogen (N₂) with a gas flow rate of 0.29 kg/h. The injector open time was 10 sec and the pressure was maintained at 140 bar. A gas load of 0.5 wt % was used with an injection speed of 75 mm/s. The weight of the RHS 17/021 material used was 146 g. The resulting sample has a density of 0.449 g/cm³, as measured using a density scale. No condensation catalyst was added and the precision opening was 2 mm. The material properties for Example 20 are listed below in Table 5, where the compression set values were measured according to ASTM D 395 and the density values were measured by measuring the weight, length, width and thickness of a sample (approximately 9 cm×10 cm, and 0.2-0.5 cm in thickness). FIG. 11 provides a micrographs of a cross-section of the midsole formed using the supercritical nitrogen fluid as the foaming agent as disclosed in this example.

TABLE 5
Compression Set
6 h/50° C.

| Compression | 30 min | 24 hr | 48 hr |
|---|---|---|---|
| 25% | 19.2% | 2.6% | −1.3% |
| 50% | 18.9% | 10.9% | 5.8% |
| Density | % Rebound | ASKER C | ShA |
| 0.41 | 55.6 | 52.2 | 35 |

### Example 21

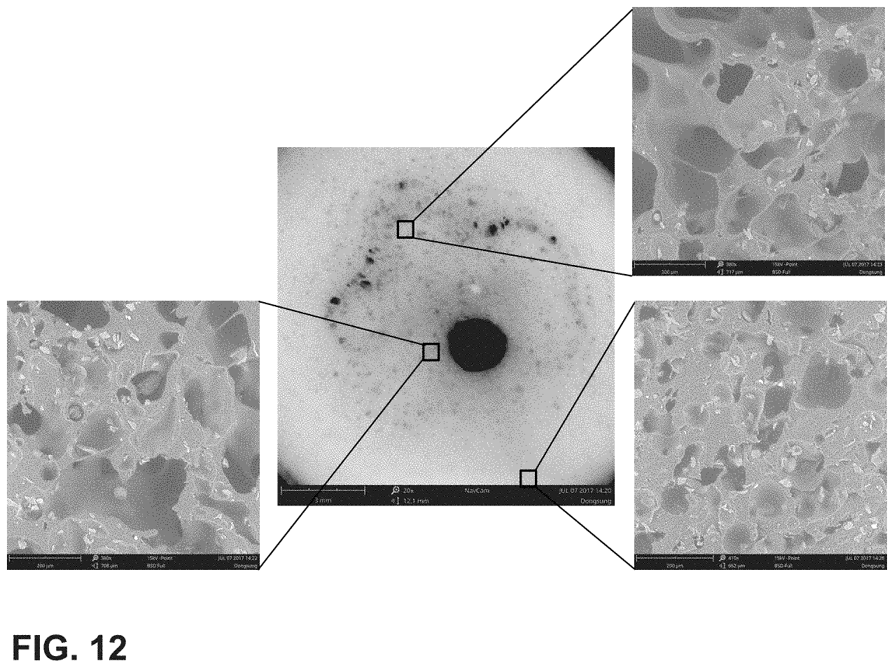

A foamed midsole was prepared using a reactive twin-screw extruder to extrude 82.55 wt % ENGAGE™ 8842 and 14.45 wt % MOSTEN™ B 003 together with 3.0 wt % SILAN RHS 14/032 or SILFIN 29 to form the ED76-4A silane-grafted polyolefin elastomer. Next, a reactive single screw extruder 288 was then used to load and extrude silane-grafted polyolefin elastomer, with 1.0 wt % dioctyltin dilaurate (DOTL) condensation catalyst, and 10 wt % MEBA chemical foaming agent. The density of the corresponding crosslinked foam polyolefin elastomers midsole 18 was 0.304 g/cm³, as measure using a density scale. The compression set data for Example 8 is listed below in Table 6. FIG. 12 provides three different micrographs of cross-sections of midsoles formed using the MEBA chemical foaming agent according to this example.

TABLE 6
Compression Set
6 h/50° C.

| Compression | 30 min | 24 hr | 48 hr |
|---|---|---|---|
| 25% | 22.1% | 17.2% | 18.4% |
| 50% | 14.6% | 12.9% | 10.4% |

### Example 22

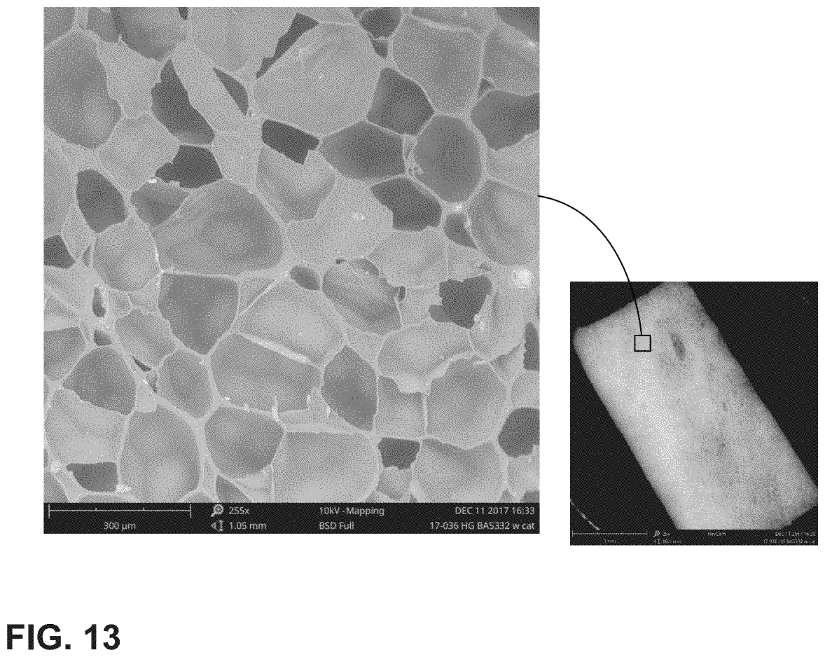

A foamed midsole having a relatively high concentration of silane grafts was prepared using a reactive twin-screw extruder to extrude 59.00 wt % INFUSE™ 9530, 30.00 wt % INFUSE™ 9817, and 8.00 wt % MOSTEN™ NB 425 together with 3.0 wt % SILAN RHS 14/032 or SILFIN 29 to form the silane-grafted polyolefin elastomer. Next, a reactive single screw extruder was then used to load and extrude silane-grafted polyolefin elastomer, with 1.0 wt % dioctyltin dilaurate (DOTL) condensation catalyst, and 10 wt % MEBA chemical foaming agent. The density of the corresponding crosslinked foam polyolefin elastomers midsole 18 was 0.116 g/cm³, as measure using a density scale. The compression set data for Example 22 is listed below in Table 7. FIG. 13 provides a micrographs of a cross-section of the midsole formed using the MEBA chemical foaming agent according to this example.

TABLE 7
Compression Set
6 h/50° C.

| Compression | 30 min | 24 hr | 48 hr |
|---|---|---|---|
| 50% | 61.3% | 42.9% | 31.1% |

### Example 23

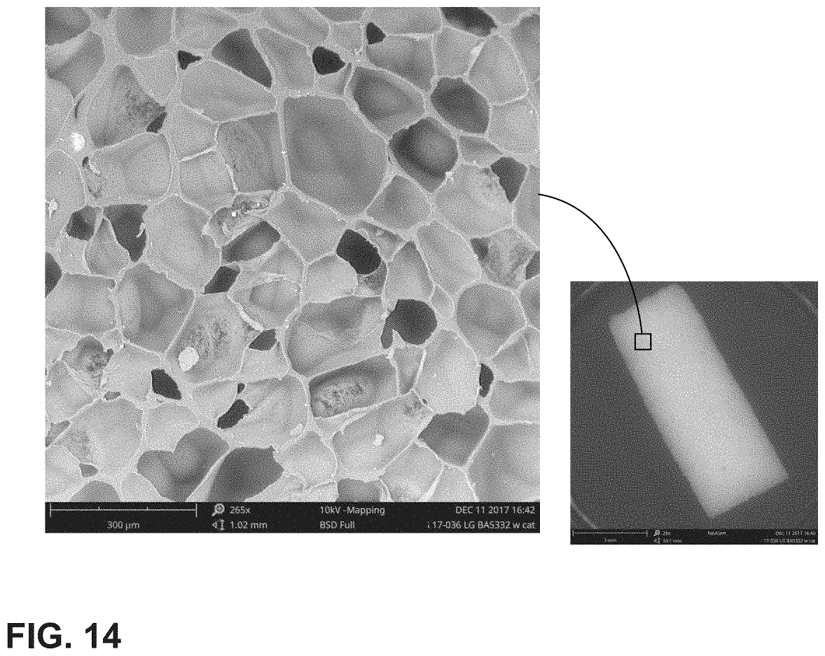

A foamed midsole having a relatively low concentration of silane grafts was prepared using a reactive twin-screw extruder to extrude 59.00 wt % INFUSE™ 9530, 30.00 wt % INFUSE™ 9817, and 8.00 wt % MOSTEN™ NB 425 together with 3.0 wt % SILAN RHS 14/032 or SILFIN 29 to form the silane-grafted polyolefin elastomer. Next, a reactive single screw extruder was then used to load and extrude silane-grafted polyolefin elastomer, with 1.0 wt % dioctyltin dilaurate (DOTL) condensation catalyst, and 10 wt % MEBA chemical foaming agent. The density of the corresponding crosslinked foam polyolefin elastomers midsole 18 was 0.116 g/cm³, as measure using a density scale. The compression set data for Example 23 is listed below in Table 8. FIG. 14 provides a micrograph of a cross-section of the midsole formed using the MEBA chemical foaming agent according to this example.

TABLE 8
Compression Set
6 h/50° C.

| Compression | 30 min | 24 hr | 48 hr |
|---|---|---|---|
| 25% | 45.3% | 31.1% | 26.1% |

### Footwear Static Compression Examples

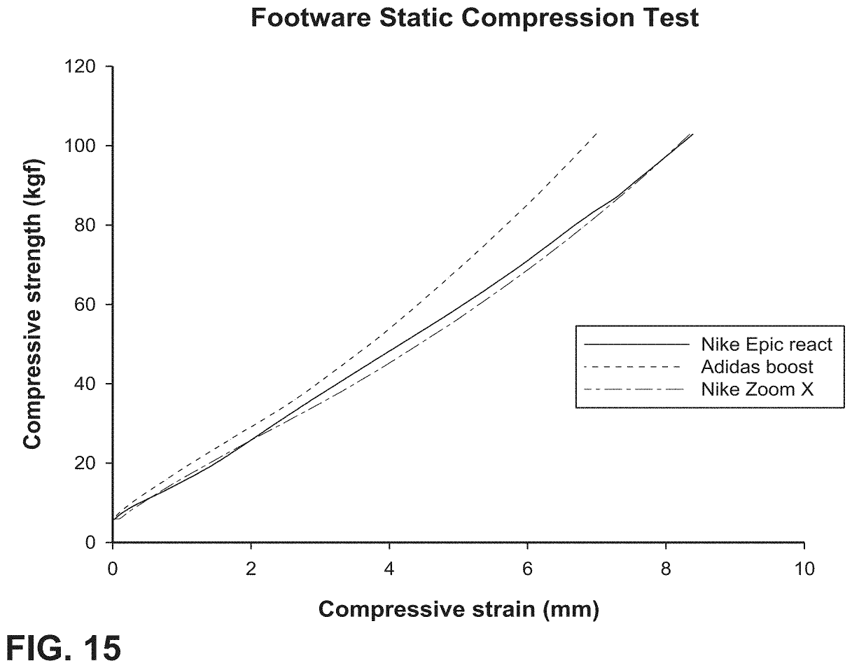

Three different brands and models of athletic shoes were measured to determine their static compression. Shoe sample 1 was a size 12 Epic React made by Nike. Shoe Sample 2 was size 9.5 Pure Boost made by Adidas. Shoe sample 3 was a size 15 Zoom X made by Nike. The respective shoe samples with their brand, model, and size are provided in Table 9. FIG. 15 is a static compression plot providing compressive strength versus compressive strain for a variety of commercially available shoe soles listed in Table 9.

TABLE 9

| | Shoe Sample 1 | Shoe Sample 2 | Shoe Sample 3 |
|---|---|---|---|
| Brand | Nike | Adidas | Nike |
| Model | Epic react | Pure Boost | Zoom X |
| Size | 12 (290) | 9.5 (275) | 15 (330) |

### Examples 24-28

A foamed midsole was prepared by dry blending or mixing the various components together and using an injection molding system at 190° C. for 360 seconds to form Examples 24-28. The components used in Examples 24-28 are listed below in Table 10 and include a silane-grafted polyolefin elastomer having vinyltrimethoxy silane (VTMO) incorporated (MSX-041), a silane-grafted polyolefin elastomer having vinyltriethoxy silane (VTEO) incorporated (MSX-042), an ethylene vinyl acetate copolymer (SD-2)(SD-7)(SD-21), and/or a blowing agent such as azodicarbonamide (ADCA) listed as JTR-TL. The injection molding system was then used to inject the mixed Example 24-28 compositions having a condensation catalyst RHS 14/023 (e.g., dioctyltin dilaurate (DOTL)). The measured Density, Expansion Ratio A/B direction (ER %), Hardness (C type), Resilience, Compression Set, Split Tear, and T-shrinkage values for the corresponding crosslinked foam polyolefin elastomers in Examples 24-28 are additionally provided in Table 10.

TABLE 10

| | Example | Example | Example | Example | Example | Test |
|---|---|---|---|---|---|---|
| | 24 | 25 | 26 | 27 | 28 | Method |
| MSX 041 | 70 | — | — | — | — | |
| MSX 042 | — | 70 | 70 | 70 | 70 | |
| SD-2 | 15 | 15 | — | — | 15 | |
| SD-7 | 15 | 15 | — | — | 15 | |
| SD-21 | — | — | 30 | 30 | — | |
| RHS 14/023 | — | 3 | — | 3 | — | |
| JTR/TL | 5 | 5 | — | — | 5 | |
| Expansion | 154/158 | 163/166 | 184/186 | — | 176/178 | — |
| Ratio A/B % | | | | | | |
| Specific | 0.220 | 0.172 | 0.121 | — | 0.135 | ASTM D 2240 |
| Gravity | | | | | | |
| Hardness | 41 | 34 | 20 | — | 27 | ASTM D 297 |
| Resilience | 62 | 62 | 64 | — | 62 | ASTM D 395 |
| (%) | | | | | | |
| Compression | 40 | 49 | 77 | — | 65 | KS M ISO |
| Set (%) | | | | | | 8307 |
| Split tear | 1.5 | 1.8 | 0.8 | — | 1.0 | ASTM D 3574 |
| (Kg/cm) | | | | | | |
| Remarks | Nike | 10 mm | 10 mm | 10 mm | 10 mm | 15°, 6 pound |
| | Slab | | | | | 3,000 cycles |

### Example 29

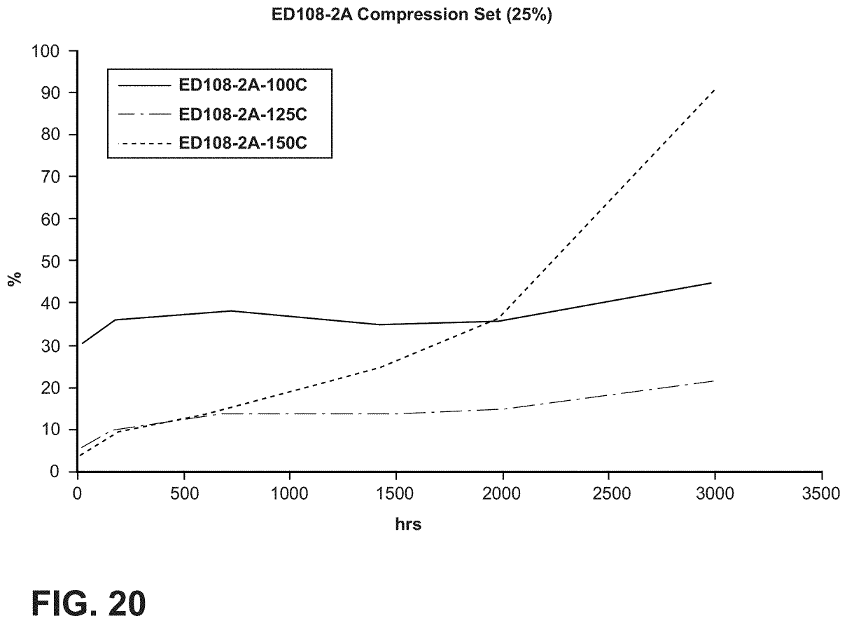

A foamed midsole was prepared using a reactive twin-screw extruder to extrude 48.7 wt % ENGAGE™ XLT8677 or XUS 38677.15 and 48.7 wt % ENGAGE™ 8842 together with 2.6 wt % SILAN RHS 14/032 or SILFIN 29 to form the ED108-2A silane-grafted polyolefin elastomer. Next, a reactive single screw extruder equipped with the supercritical fluid injector was employed to further process the blend, where the supercritical fluid medium was nitrogen (N₂) with a gas flow rate of 0.29 kg/h. The injector open time was 10 sec and the pressure was maintained at 140 bar. A gas load of 0.5 wt % was used with an injection speed of 75 mm/s. The weight of the ED108-2A material used was 153.7 g. The resulting sample has a density of 0.392 g/cm³, as measured using a density scale. No condensation catalyst was added and the precision opening was 0.7 mm. FIG. 20 is a graph illustrating the compression set of the inventive crosslinked foamed polyolefin elastomer (ED108-2A) as plotted with respect to temperatures ranging from 100° C. to 150° C.

It will be understood by one having ordinary skill in the art that construction of the described device and other components may not be limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

The above description is considered that of the illustrated embodiments only.

Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A footwear article, comprising:
a shoe sole,
wherein the shoe sole comprises a crosslinked foam polyolefin elastomer having a density less than 0.88 g/cm³, the crosslinked foam polyolefin elastomer comprising:
a silane-grafted polyolefin elastomer, a silane-grafted olefin block copolymer, a polyolefin elastomer (POE), an olefin block copolymer (OBC), or a combination thereof;
an ethylene vinyl acetate (EVA) copolymer;
a crosslinker;
a condensation catalyst; and
a foaming agent,
wherein the shoe sole exhibits a compression set of from about 1.0% to about 50.0%, as measured according to ASTM D 395 (48 hrs @ 50° C.).

2. The footwear article of claim 1, wherein the silane-grafted polyolefin elastomer and/or the silane-grafted olefin block copolymer comprises from about 60 wt % to about 97 wt % of an ethylene/α-olefin copolymer.

3. The footwear article of claim 1 or claim 2, wherein the crosslinker comprises one or more halogen molecules, azo compounds, carboxylic peroxyacids, peroxyesters, peroxyketals, and peroxides, and the crosslinker is present in an amount from greater than 0.15 wt % to about 2 wt % of the crosslinked foam polyolefin elastomer.

4. The footwear article of claim 1, wherein the condensation catalyst comprises an acidic catalyst and/or a tin-based catalyst and the condensation catalyst is present in an amount from about 1 wt % to about 4 wt % of the crosslinked foam polyolefin elastomer.

5. The footwear article of claim 1, wherein the density of the crosslinked foam polyolefin elastomer is from about 0.35 g/cm³ to about 0.50 g/cm³.

6. The footwear article of claim 1, wherein the shoe sole exhibits an Asker C hardness of from about 20 to about 60, a rebound resilience of at least 60%, or both.

7. The footwear article of claim 1, further comprising a coloring agent.

8. A crosslinked foam polyolefin elastomer composition comprising:
a silane-grafted polyolefin having a density less than 0.86 g/cm³,
a crosslinker,
a condensation catalyst, and
a foaming agent,
wherein the polyolefin elastomer composition exhibits a compression set of from about 1.0% to about 50.0%, as measured according to ASTM D 395 (48 hrs @ 50° C.), and a density less than 0.88 g/cm³.

9. The crosslinked foam polyolefin elastomer composition of claim 8, wherein the silane-grafted polyolefin comprises a silane-grafted polyolefin elastomer, a silane-grafted olefin block copolymer, a polyolefin elastomer (POE), an olefin block copolymer (OBC), or any combination thereof.

10. The crosslinked foam polyolefin elastomer composition of claim 8, further comprising an ethylene vinyl acetate (EVA) copolymer, a coloring agent, or both.

11. The crosslinked foam polyolefin elastomer composition of claim 8, wherein the silane-grafted polyolefin comprises from about 60 wt % to about 97 wt % of an ethylene/α-olefin copolymer.

12. The crosslinked foam polyolefin elastomer composition of claim 8, wherein the crosslinker comprises one or more halogen molecules, azo compounds, carboxylic peroxyacids, peroxyesters, peroxyketals, and peroxides; and the crosslinker is present in an amount from greater than 0.15 wt % to about 2 wt % of the crosslinked foam polyolefin elastomer.

13. The crosslinked foam polyolefin elastomer composition of claim 8, wherein the condensation catalyst comprises an acidic catalyst and/or a tin-based catalyst, and the condensation catalyst is present in an amount from about 1 wt % to about 4 wt % of the crosslinked foam polyolefin.

14. The crosslinked foam polyolefin elastomer composition of claim 8, wherein the density of the polyolefin elastomer is from about 0.35 g/cm³ to about 0.50 g/cm³.

15. The crosslinked foam polyolefin elastomer composition of claim 8, wherein the crosslinked foam polyolefin elastomer composition exhibits an Asker C hardness of from about 20 to about 60, a rebound resilience of at least 60%, or both.

16. A method for making a shoe sole, the method comprising:
extruding a silane-grafted polyolefin, an ethylene vinyl acetate (EVA) copolymer, a crosslinker, a foaming agent, and a condensation catalyst together to form a crosslinkable polyolefin blend;
injection molding the crosslinkable polyolefin blend into a shoe sole element;
crosslinking the crosslinkable polyolefin blend of the shoe sole element using a dual crosslinking system to form silane graft-silane graft crosslinks and carbon-carbon crosslinks at a temperature greater than 150° C. to form a shoe sole; and
catalyzing the dual crosslinking system of the crosslinking step by generating acetic acid in situ from the ethylene vinyl acetate (EVA) copolymer, wherein the shoe sole exhibits a compression set of from about 1.0% to about 50.0%, as measured according to ASTM D 395 (48 hrs @ 50° C.) and has a density less than 0.88 g/cm³.

17. The method of claim 16, wherein the silane-grafted polyolefin comprises a silane-grafted polyolefin elastomer, a silane-grafted olefin block copolymer, a polyolefin elastomer (POE), an olefin block copolymer (OBC), or a combination thereof.

18. The method of claim 16, wherein the silane-grafted polyolefin comprises from about 60 wt % to about 97 wt % of an ethylene/α-olefin copolymer.

19. The method of claim 16, wherein the crosslinker comprises one or more halogen molecules, azo compounds, carboxylic peroxyacids, peroxyesters, peroxyketals, and peroxides, the crosslinker is present in an amount from greater than 0.15 wt % to about 2 wt % of the crosslinkable polyolefin blend.

20. The method of claim 16, wherein the condensation catalyst comprises an acidic catalyst and/or a tin-based catalyst, and the condensation catalyst is present in an amount from about 1 wt % to about 4 wt % of the crosslinkable polyolefin blend.

21. The method of claim 16, wherein the shoe sole has a density from about 0.35 g/cm³ to about 0.50 g/cm³.

22. The method of claim 16, wherein the foaming agent comprises a supercritical fluid, the crosslinkable polyolefin blend further comprises a coloring agent, or both.

23. The method of claim 16, wherein the shoe sole exhibits a rebound resilience of at least 60%, an Asker C hardness of from about 20 to about 60, or both.

24. The method of claim 16, further the method further comprises:
using a pull back and/or variotherm process to facilitate the crosslinking step.
